(19) United States
(12) Patent Application Publication
(10) Pub. No.: US 2013/0179532 A1
(43) Pub. Date: Jul. 11, 2013

(54) COMPUTER SYSTEM AND SYSTEM SWITCH CONTROL METHOD FOR COMPUTER SYSTEM

(71) Applicants: Takashi Tameshige, Tokyo (JP); Yoshifumi Takamoto, Kokubunji (JP); Takeshi Teramura, Yokohama (JP)

(72) Inventors: Takashi Tameshige, Tokyo (JP); Yoshifumi Takamoto, Kokubunji (JP); Takeshi Teramura, Yokohama (JP)

(73) Assignee: HITACHI, LTD., Tokyo (JP)

(21) Appl. No.: 13/806,650

(22) PCT Filed: Aug. 25, 2010
(86) PCT No.: PCT/JP2010/064384

§ 371 Date: Mar. 27, 2013

(30) Foreign Application Priority Data
Jul. 8, 2010 (JP) 2010-155596

(51) Int. Cl. G06F 15/167

(52) U.S. Cl. CPC G06F 15/167
USPC 709/213

(57) ABSTRACT

Disclosed is a computer system provided with an I/O processing unit comprising a buffer and a control unit, wherein the buffer is located between the first computer and a storage apparatus and between a second computer and the storage apparatus and temporarily stores an I/O output from a first computer, and the control unit outputs data stored in the buffer to the storage apparatus, and wherein, a management computer functions to store the I/O output of the first computer in the buffer at a predetermined time, to separate a first storage unit and a second storage unit which are mirror volumes, to connect the buffer and the second storage unit, to connect the second computer and the first storage unit, to output data stored in the buffer to the second storage unit, and to activate the second computer using the first storage unit.

### BACKGROUND

This invention relates to a cold standby system for switching from a computer in which a failure has occurred, and more particularly, relates to a technology of improving availability by speeding up the switching of systems.

In a computer system, memory dump output by an OS of a computer in which a failure has occurred is useful information in identifying the cause of the failure. It is also important for the computer system to enable the failing computer system to recover quickly and to resume the service. For instance, there has been proposed a method of obtaining memory dump for failure analysis at the time of switching systems in a cold standby system. The switching of systems is executed by coupling logical units (LUs) to a standby system after the active system finishes outputting memory dump, which takes time because memory dump collection and system switching are sequential. Implementing speedy recovery in which the service is resumed in a standby system soon after a failure while collecting memory dump is therefore sought after. In addition, some OSs need to have a memory dump-use area in a boot volume and cannot separate the memory dump-use area.

Japanese Patent Application Laid-open No. 2007-257486 is known as a technology for speeding up memory dump when a failure occurs.

### SUMMARY

Conventional cold standby systems have no other choices than to wait for the completion of memory dump output before switching systems, or to employ a system configuration incompatible with some OSs in which an LU serving as the destination of memory dump output is separated from the boot volume.

In Japanese Patent Application Laid-open No. 2007-257486 described above, a memory is duplicated to build a system configuration that is capable of saving data stored in the memory when system switching is executed. In Japanese Patent Application Laid-open No. 2007-257486, however, the same computer is used to collect memory dump, and therefore, there has been a problem in that memory dump cannot be collected when systems are being switched.

This invention has been made in view of the problems described above, and it is therefore an object of this invention to switch systems fast while collecting memory dump regardless of the type of the OS.

A representative aspect of the present disclosure is as follows. A computer system, comprising: a first computer comprising a processor, a memory, and an I/O interface; a second computer comprising a processor, a memory, and an I/O interface; a storage apparatus accessible from the first computer and the second computer; and a management computer coupled via a network to the first computer and the second computer to execute, at given timing, system switching in which the second computer takes over from the first computer, wherein, when a given condition is satisfied, the first computer transmits an I/O output which is data stored in the memory to be written in the storage apparatus, wherein the storage apparatus comprises a first storage module which is accessed by the first computer, and a second storage module to which data stored in the first storage module is copied by mirroring, wherein the computer system further comprises: an I/O processing module which comprises a buffer for temporarily storing the I/O output between the first computer and the storage apparatus and between the second computer and the storage apparatus, and a control module for outputting data stored in the buffer to the storage apparatus; and a switch unit for switching paths by which the I/O processing module, the first computer, and the second computer access the storage apparatus, and wherein the management computer comprises: a buffering instructing module for transmitting, to the I/O processing module, when the given timing arrives, an instruction to store the I/O output of the first computer in the buffer; a storage control module for transmitting to the storage apparatus an instruction to split the first storage module and the second storage module; a path switching module for transmitting to the switch unit an instruction to connect the buffer and the second storage module, and to couple the second computer and the first storage module; a write-out instructing module for transmitting to the I/O processing module an instruction to output the data stored in the buffer to the second storage module; and a system switching module for booting the second computer from the first storage module.

According to the embodiment of this invention, system switching from the first computer which is an active system to the second computer which is a standby system can be conducted speedily while collecting I/O output from the first computer at given timing, such as the occurrence of a failure, without fail, regardless of the type of the OS.

### BRIEF DESCRIPTION OF THE DRAWINGS

FIG. 1 is a block diagram illustrating an example of a computer system which switches systems according to a first embodiment of this invention.

FIG. 2 is a block diagram illustrating the configuration of the management server according to the first embodiment of this invention.

FIG. 3 is a block diagram illustrating the configuration of the active servers or the standby servers according to a first embodiment of this invention.

FIG. 4 is a block diagram illustrating the configuration of the PCI ex-SW and the adapter according to the first embodiment of this invention.

FIG. 5 is a block diagram outlining failover which is led by the PCIex-SW according to the first embodiment of this invention.

FIG. 6 is an explanatory diagram illustrating the server management table according to the first embodiment of this invention.

FIG. 7 is an explanatory diagram illustrating the LU mapping management table according to the first embodiment of this invention.

FIG. 8 is an explanatory diagram illustrating the LU management table according to the first embodiment of this invention.

FIG. 9 is an explanatory diagram illustrating the I/O buffering management table within the I/O processing module of the PCIex-SW according to the first embodiment of this invention.

FIG. 10 is a flow chart illustrating an example of processing that is executed in the control module of the management server according to the first embodiment of this invention.

FIG. 11 is a flow chart illustrating an example of processing that is executed in the I/O buffering instructing module of the management server according to the first embodiment of this invention.

FIG. 12 is a flow chart illustrating an example of processing that is executed in the path switching module of the management server according to the first embodiment of this invention.

FIG. 13 is a flow chart illustrating an example of processing that is executed in the I/O buffer write-out instructing module of the management server according to the first embodiment of this invention.

FIG. 14 is a flow chart illustrating an example of processing that is executed in the N+M switching instructing module of the management server according to the first embodiment of this invention.

FIG. 15 is a flow chart illustrating an example of processing that is executed in the I/O buffering control module of the I/O processing module according to the first embodiment of this invention.

FIG. 16 is an explanatory diagram illustrating an example of the service and SLA management table which is managed by the management server according to the first embodiment of this invention.

FIG. 17 is a block diagram illustrating one of the servers in a second embodiment.

FIG. 18 is diagram outlining processing of the second embodiment.

FIG. 19 is a diagram outlining failover that is led by the PCIex-SW according to a third embodiment.

FIG. 20 is a diagram illustrating an example of processing of evacuating LU1 to a preset maintenance-use area after memory dump write to LU1 is finished according to the first embodiment of this invention.

### DETAILED DESCRIPTION OF THE PREFERRED EMBODIMENTS

### First Embodiment

An embodiment of this invention is described below with reference to the accompanying drawings.

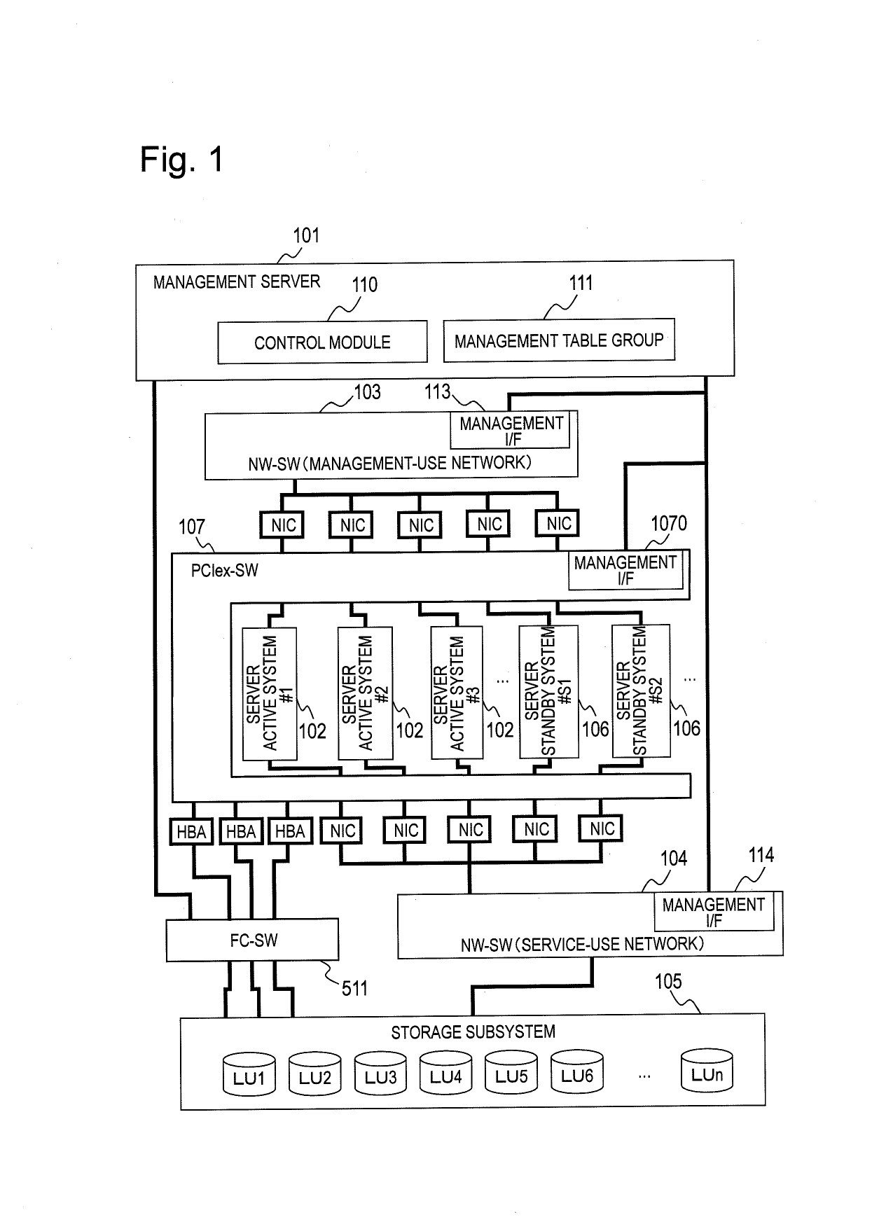

FIG. 1 is a block diagram illustrating an example of a computer system which switches systems according to a first embodiment of this invention.

A management server 101 is coupled, via a NW-SW (management-use network switch) 103, to a management interface (management I/F) 113 of the NW-SW 103 and to a management interface 114 of a NW-SW (service-use network switch) 104, so that virtual LANs (VLANs) of the respective NW-SWs can be set from the management server 101.

The NW-SW 103 constitutes a management-use network which is a network for the running and management of active servers 102 and standby servers 106 such as the distribution of an OS or an application and power supply control. The NW-SW 104 constitutes a service-use network which is a network used by a service application that is executed on the servers 102 and 106. The NW-SW 104 is coupled to a WAN or the like to communicate to/from a client computer outside the computer system.

The management server 101 is coupled to a storage subsystem 105 via a FC-SW (fiber channel switch) 511. The management server 101 manages N logical units LU1 to LUn provided in the storage subsystem 105.

A control module 110 for managing the servers 102 and 106 are executed on the management server 101, and refers to and updates a management table group 111. The management table group 111 is updated by the control module 110 in given cycles or the like.

The servers 102 to be managed are active servers in the system which provides N+M cold standby and, together with the physical servers 106 which are standby systems, are coupled to the NW-SW 103 and the NW-SW 104 via a PCIex-SW 107 and I/O devices (HBAs in the figure). Connected to the PCIex-SW 107 are I/O devices of PCI Express standards (I/O adapters such as network interface cards (NICs), host bus adapters (HBAs), and converged network adapters (CNAs)). The PCIex-SW 107 is generally hardware constituting an I/O switch for extending a PCI Express bus to the outside of a motherboard (or server blade) to make it possible to connect more PCI-Express devices. The N+M cold standby system includes N active servers 102 and M standby servers 106. The number of the active servers 102 and the number of the standby servers 106 desirably satisfy N>M.

The computer system of this embodiment implements an N+M cold standby system by switching communication paths within the PCIex-SW 107. In the N+M cold standby system, when a failure occurs in one of the active servers 102, the management server 101 executes system switching in which a service of this server 102 is taken over by one of the standby servers 106. In system switching, memory dump of the active server 102 which is output as a particular I/O output from the moment the failure occurred is collected without missing a piece, and failover is executed immediately after the failure so that the standby server 106 can take over a service system which has been run on the failing active server 102. The service system can thus continue operating with only a brief interruption required for reboot while the cause of the failure is being identified from the collected memory dump.

The management server 101 is connected to a management interface 1070 of the PCIex-SW 107 to manage connection relations between the servers 102 and 106 and the I/O devices.

The servers 102 and 106 access the logical units LU1 to LUn of the storage subsystem 105 via the I/O devices (HBAs in the figure) connected to the PCIex-SW 107. A disk interface 203 is an interface for a built-in disk of the management server 101 and for the storage subsystem 105. The active servers 102 are discriminated from one another by “#1” to “#3” in the figure, and the standby servers 106 are discriminated from one another by “#S1” and “#S2” in the figure.

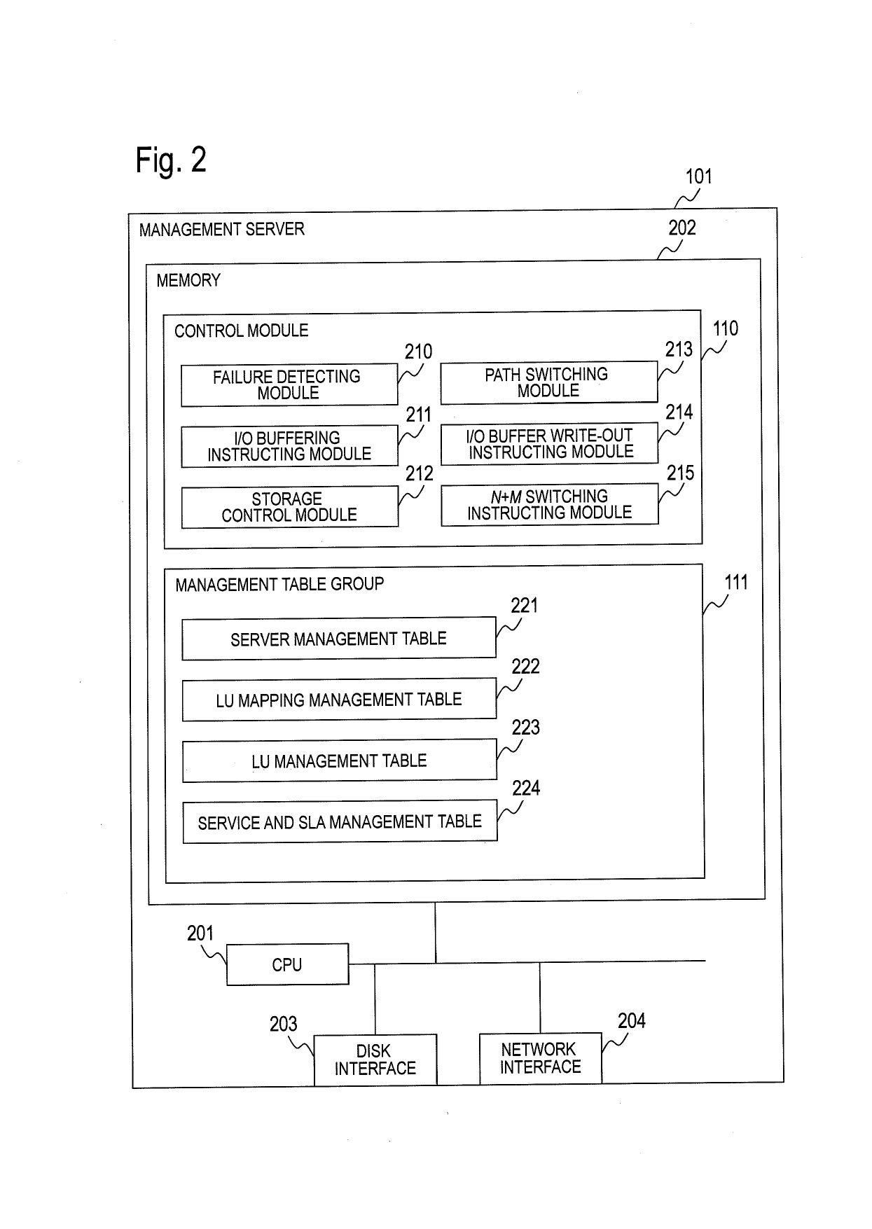

FIG. 2 is a block diagram illustrating the configuration of the management server 101. The management server 101 includes a central processing unit (CPU) 201, which handles computing processing, a memory 202, which stores a program computed by the CPU 201 and data involved in the execution of the program, the disk interface 203, which is an interface to a storage apparatus storing a program and data, and a network interface 204, which is for communication over an IP network.

FIG. 2 illustrates one network interface 204 and one disk interface 203 each as a representative, but the management server 101 includes a plurality of network interfaces 204 and a plurality of disk interfaces 203. For instance, different network interfaces 204 are used to couple the management server 101 to the management-use network NW-SW 103, and to couple the management server 101 to the service-use network NW-SW 104.

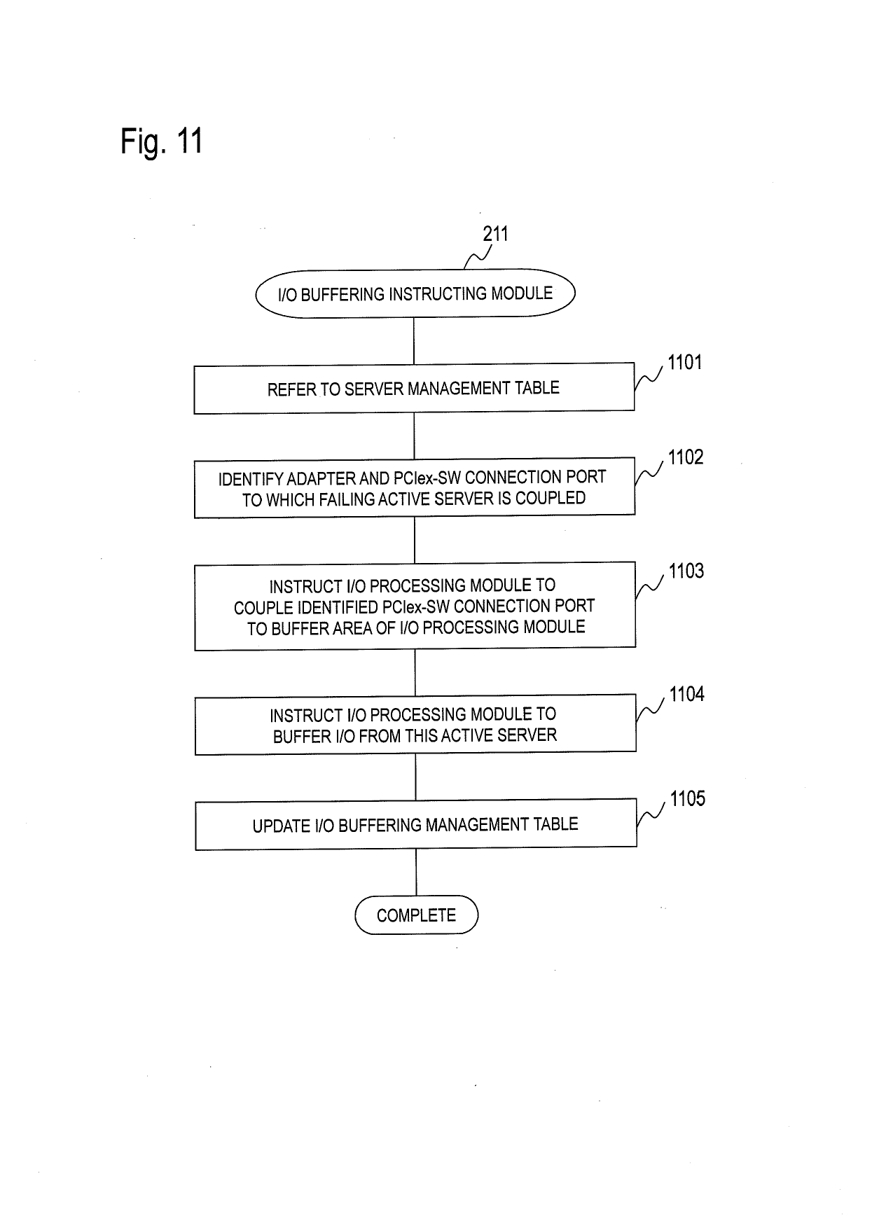

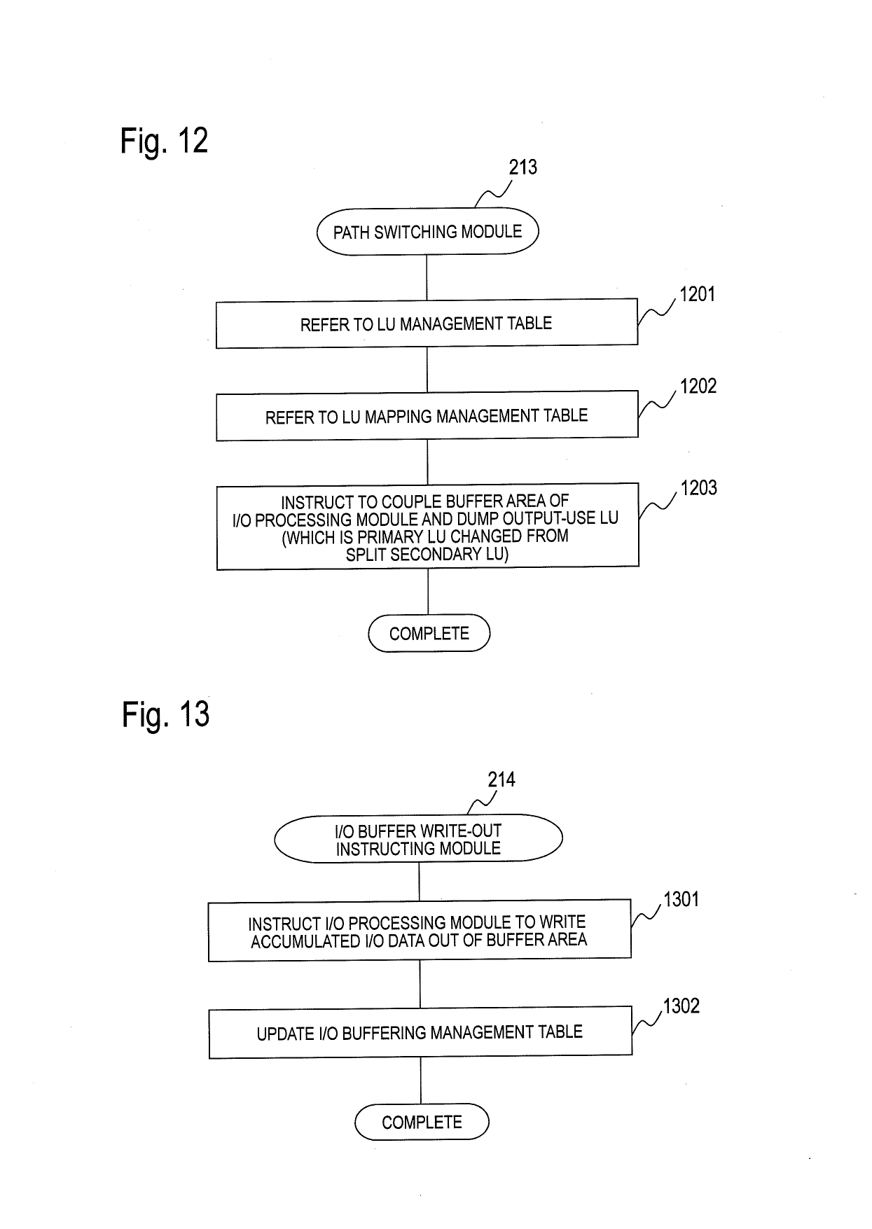

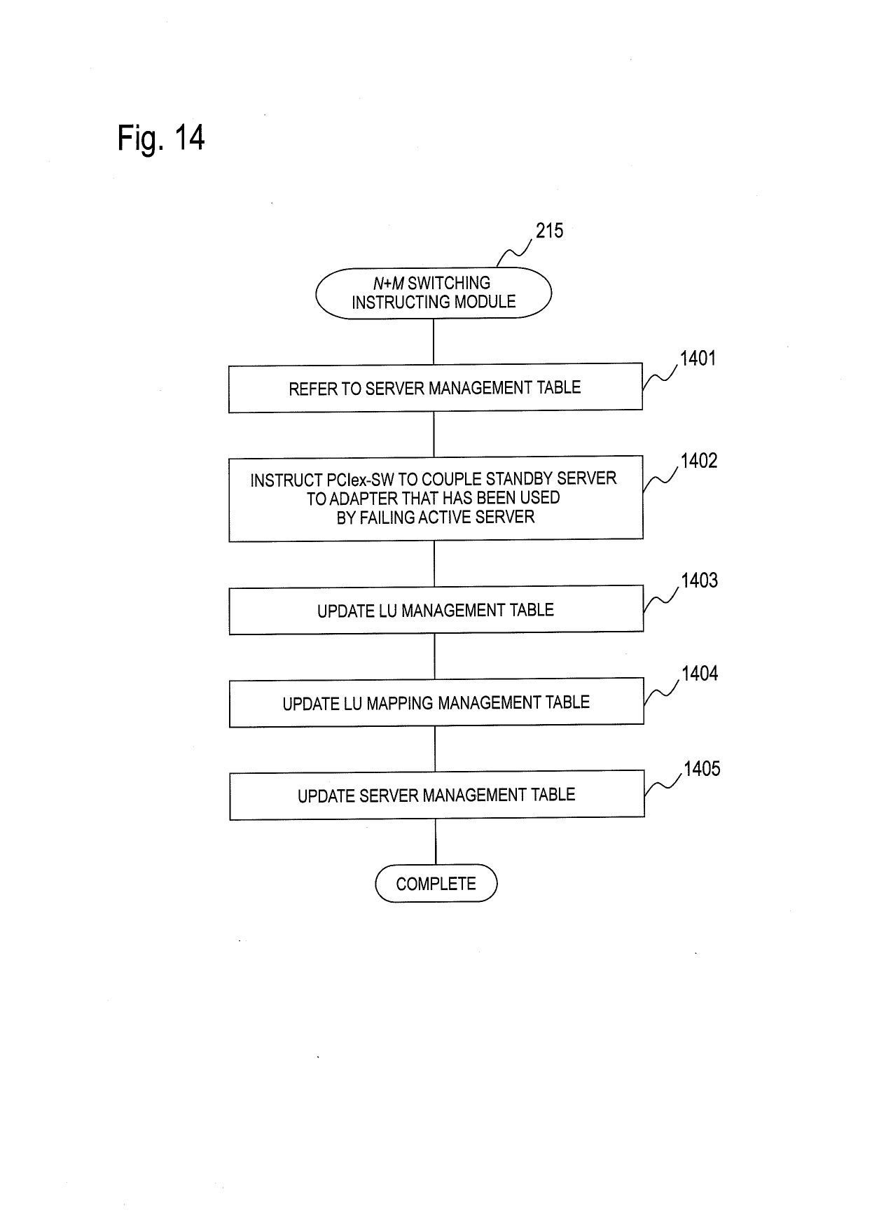

The memory 202 stores the control module 110 and the management table group 111. The control module 110 includes a failure detecting module 210, an I/O buffering instructing module 211 (see FIG. 11), a storage control module 212, a path switching module 213 (see FIG. 12), an I/O buffer write-out instructing module 214 (see FIG. 13), and an N+M switching instructing module 215 (see FIG. 14).

The failure detecting module 210 detects a failure in the servers 102 and 106 and, when a failure is detected, the N+M switching instructing module 215 refers to a server management table 221, which is described later, and executes the system switching described above. Well-known technologies are applicable to the failure detection and failover, and details thereof are not described in this embodiment.

The storage control module 212 uses an LU management table 223, which is described later, to manage the logical units LU1 to LUn of the storage subsystem 105.

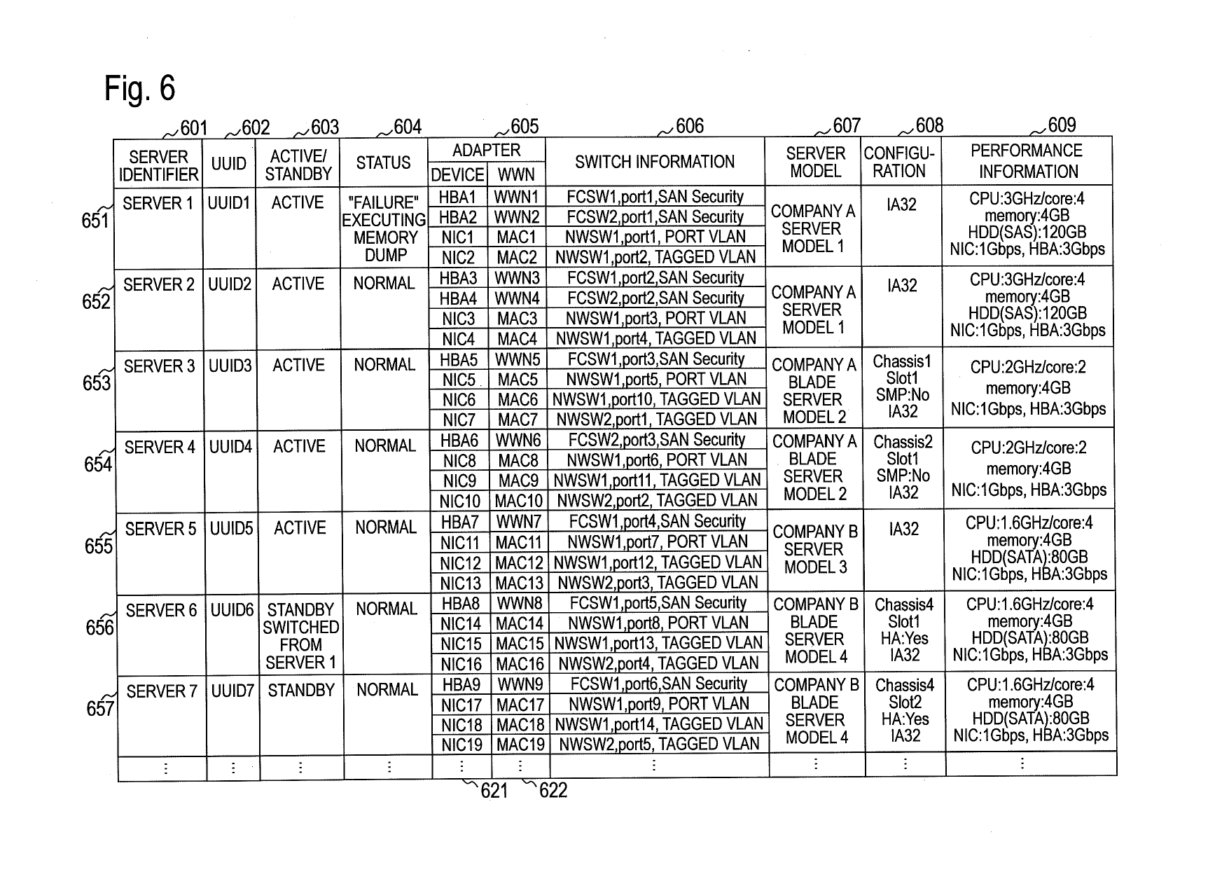

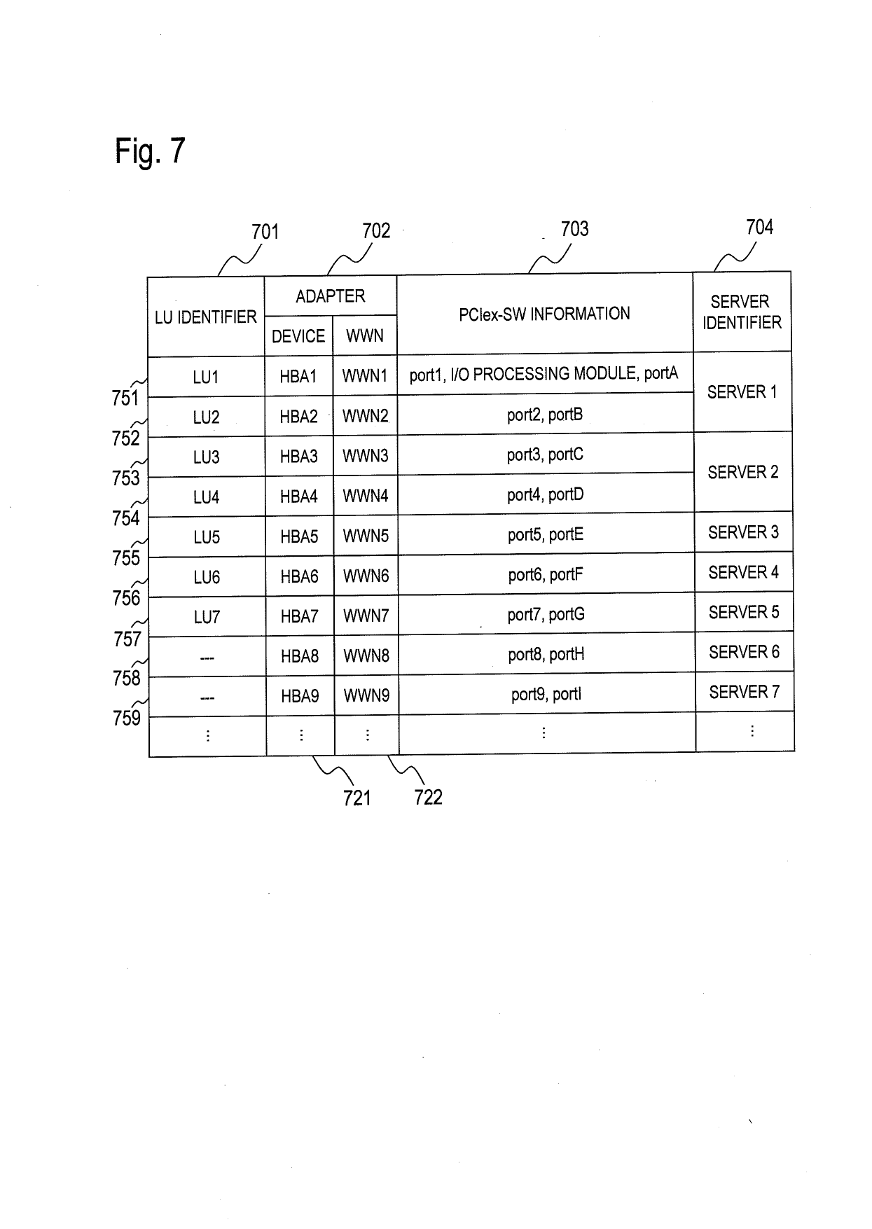

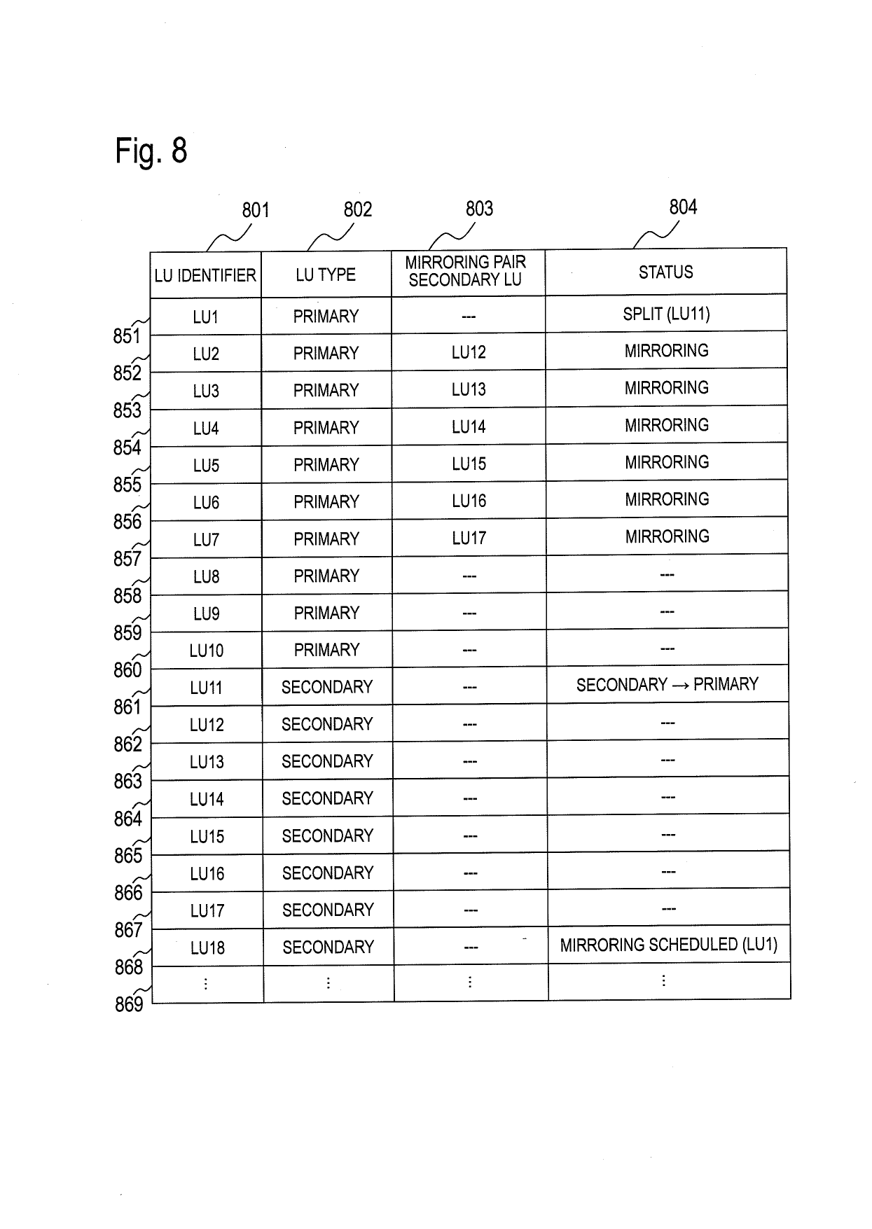

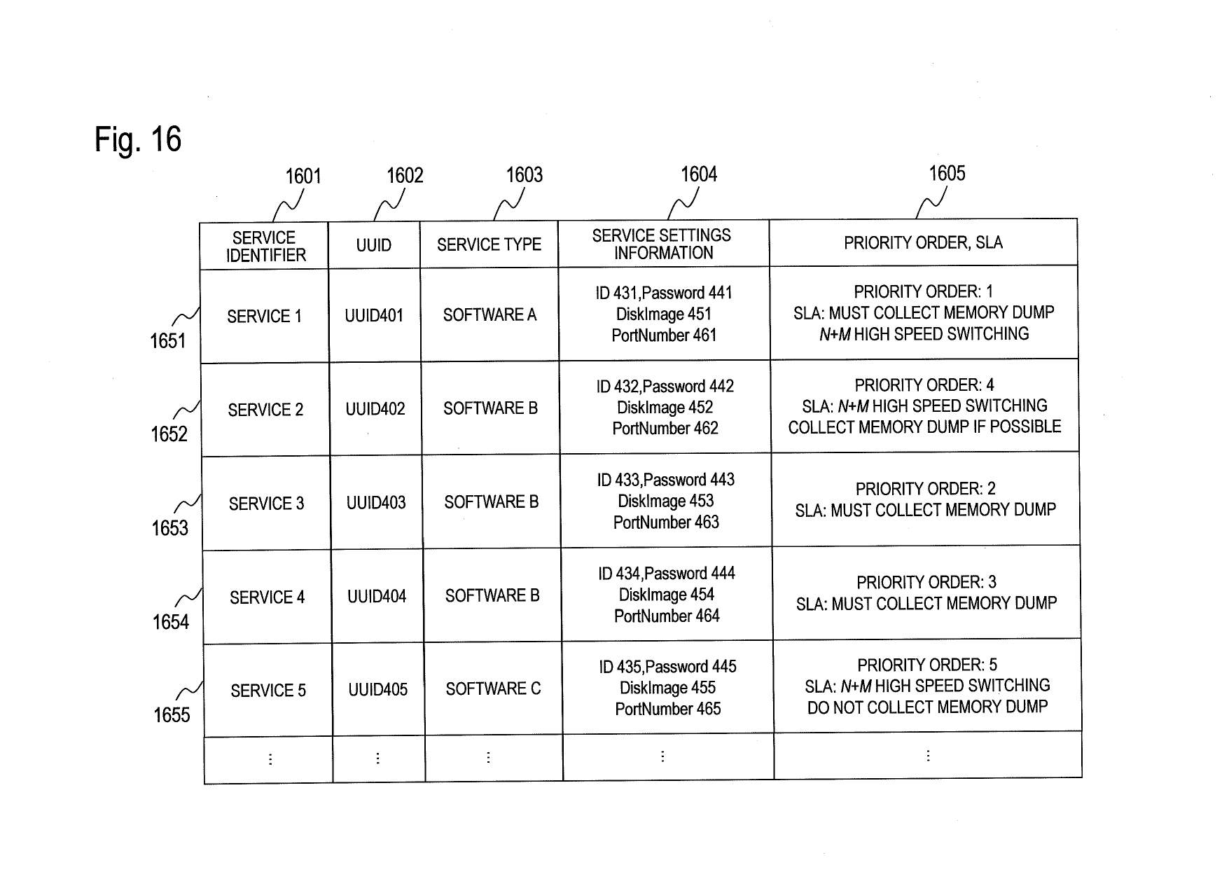

The management table group 111 includes the server management table 221 (see FIG. 6), an LU mapping management table 222 (see FIG. 7), the LU management table 223 (see FIG. 8), and a service and service level agreement (SLA) management table 224 (see FIG. 16).

Information of the respective tables may be collected automatically with the use of a standard interface of the OS (not shown) or an information collecting program, or may be input manually by a user (or an administrator). However, the user needs to input, in advance, rules, policies, or similar types of information except ones whose limit values are determined by physical requirements or legal obligations, and the management server 101 may include an input-use interface that enables the user to input these values. In the case where the system is run in a manner that avoids reaching the limit values as per the policy of the user, too, the management server 101 may include an interface for inputting conditions.

The management server 101 can be of any type, for example, a physical server, a blade server, a virtualized server, or a server created by logical partitioning or physical partitioning. In any type of server, effects of this invention can be obtained.

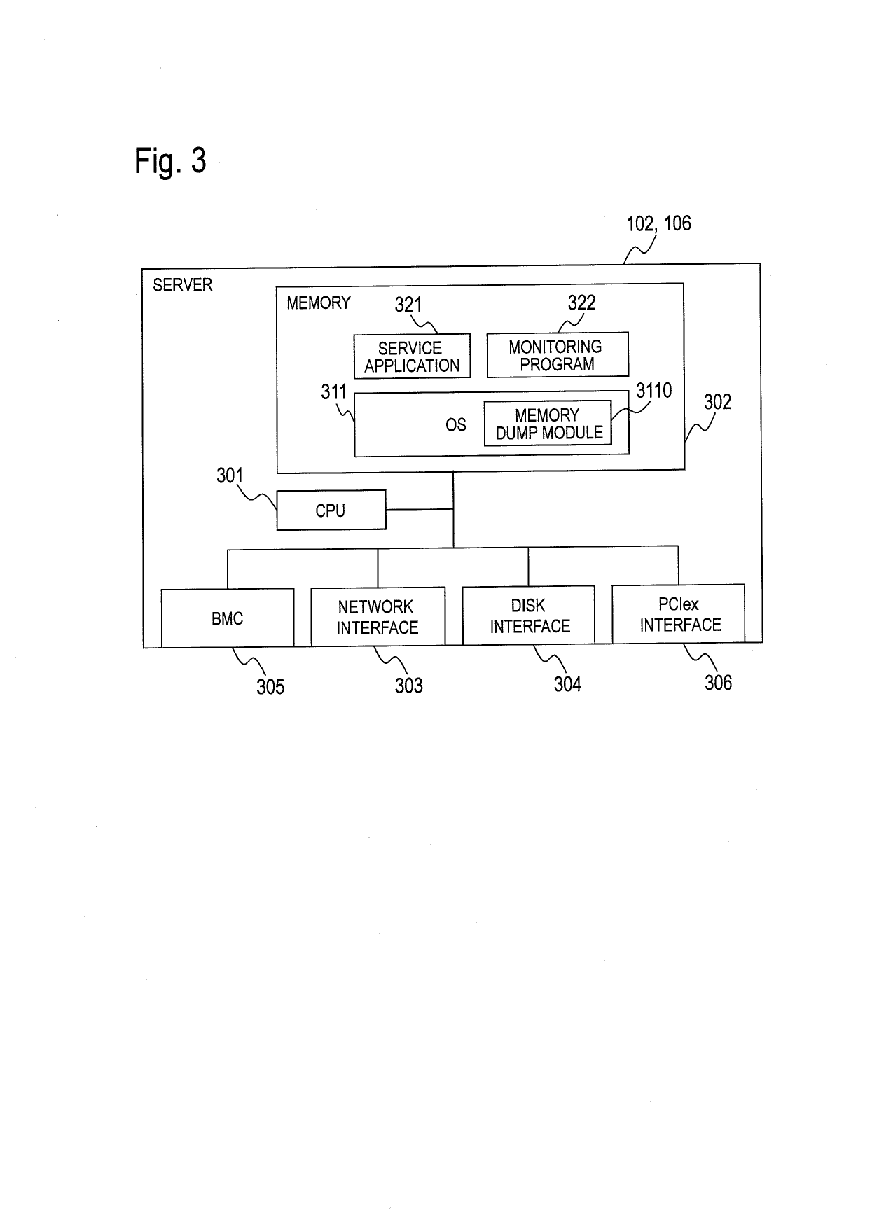

FIG. 3 is a block diagram illustrating the configuration of the active servers 102 or the standby servers 106. The active servers 102 and the standby servers 106 do not need to have a matching configuration. However, giving the active servers 102 and the standby servers 106 a matching configuration results in less trouble when switching is executed by N+M cold standby. This is because the operation of switching by N+M cold standby seems to an OS like reboot. This effect works in this invention, too. The following description deals with a case where the active servers 102 and the standby servers 106 have the same configuration.

Each server 102 or 106 includes a CPU 301, which handles computing processing, a memory 302, which stores a program computed by the CPU 301 and data involved in the execution of the program, a disk interface 304, which is an interface to a storage apparatus storing a program and data, a network interface 305, which is for communication over an IP network, a basement management controller (BMC) 305, which handles power supply control and the control of the respective interfaces, and a PCI-Express interface 306 for connecting to the PCIex-SW.

An OS 311 in the memory 302 is executed by the CPU 301 to manage devices and tasks in the server 102 or 106. An application 321, which provides a service, a monitoring program 322, and the like operate under the OS 311. The monitoring program 322 detects a failure in the server 102 or 106 and notifies the management server 101. The OS 311 includes a memory dump module 3110 which outputs data stored in the memory 302 as memory dump to be written in the storage subsystem 105 under a given condition. The OS 311 lets the memory dump module 3110 start functioning under the given condition such as the occurrence of a failure or the reception of a given command.

FIG. 3 shows one network interface 303, one disk interface 304, and one PCI-Express interface 306 each as a representative, but the server 102 or 106 includes a plurality of network interfaces 303, a plurality of disk interfaces 304, and a plurality of PCI-Express interfaces 306. For instance, different network interfaces 303 are used to couple the server 102 or 106 to the management-use network NW-SW 103, and to couple the server 102 or 106 to the service-use network NW-SW 104. Alternatively, the server 102 or 106 may be coupled to the management-use network NW-SW 103 and to the service-use network NW-SW 104 through NICs which are connected via the PCIex interfaces as in FIG. 1.

When there is no failure in any of the active servers. 102 and accordingly N+M switching is not underway, the OS 311 and other programs are not operating in the memory 302 of each standby server 106. However, the standby servers 106 may execute a program for collecting information or checking for a failure in given cycles or the like.

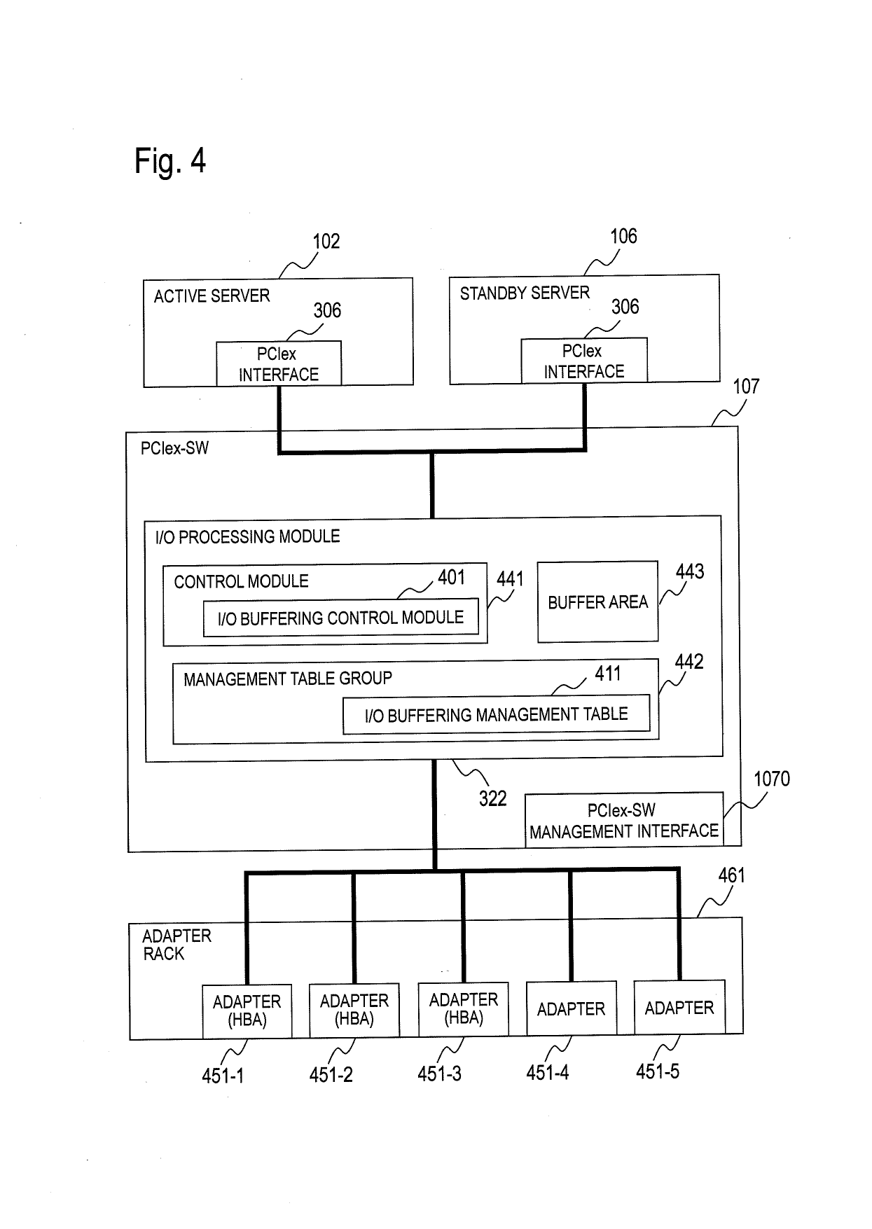

FIG. 4 illustrates, with the PCIex-SW 107 at the center, one of the active servers 102, one of the standby servers 106, PCI-Express adapters 451-1 to 451-5 (I/O devices such as NICs, HBAs, and CNAs), and an adapter rack 461, which houses the adapters 451, and the connection configuration of the PCIex-SW 107 with respect to the adapters 451 as well. The following description uses “adapters 451” as a collective term for the adapters 451-1 to 451-5.

The PCIex-SW 107 is connected to each of the active server 102 and the standby server 106 via the PCIex interface 306. The PCIex-SW 107 is also connected to the plurality of PCI express adapters 451. The adapters 451 may be housed in the adapter rack 461 or may be connected directly to the PCIex-SW 107.

The PCIex-SW 107 includes an I/O processing module 322, and has a path that connects the active server 102 or the standby server 106 to the adapters 451 through the I/O processing module 322, and a path that runs around the I/O processing module 322 in connecting the active server 102 or the standby server 106 to the adapters 451. To operate as a module for obtaining memory dump of the active server 102 without missing a piece, the I/O processing module 322 in this embodiment includes a buffer area 443 for temporarily storing the memory dump, a control module 441 for controlling the buffer area 443, and a management table group 442. The management table group 442 is updated by the control module 441 in given cycles, or in response to a configuration changing instruction from the management server 101 or the like.

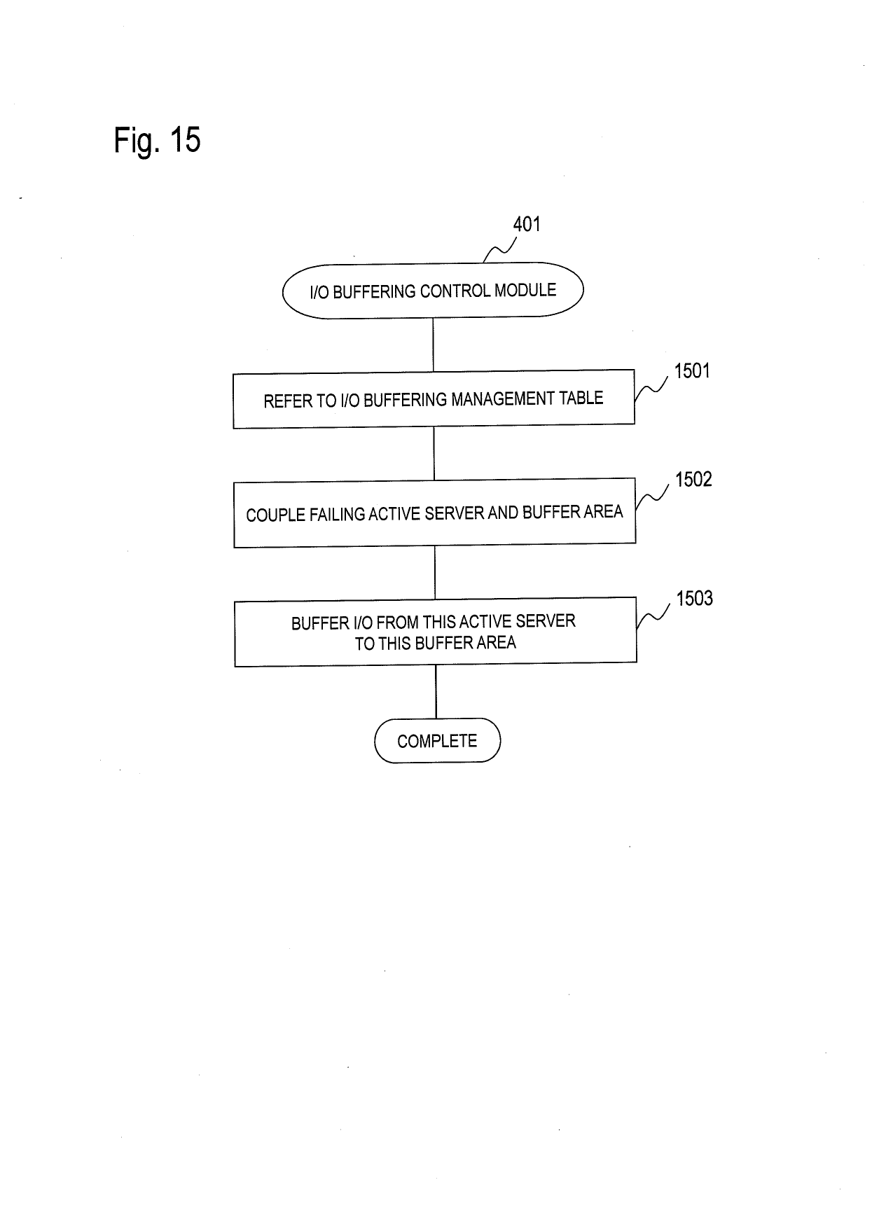

The control module 441 includes an I/O buffering control module 401 (see FIG. 15), which controls the connection of the adapters (I/O devices) 451 to the active server 102 and the standby server 106 and controls access to the buffer area 443.

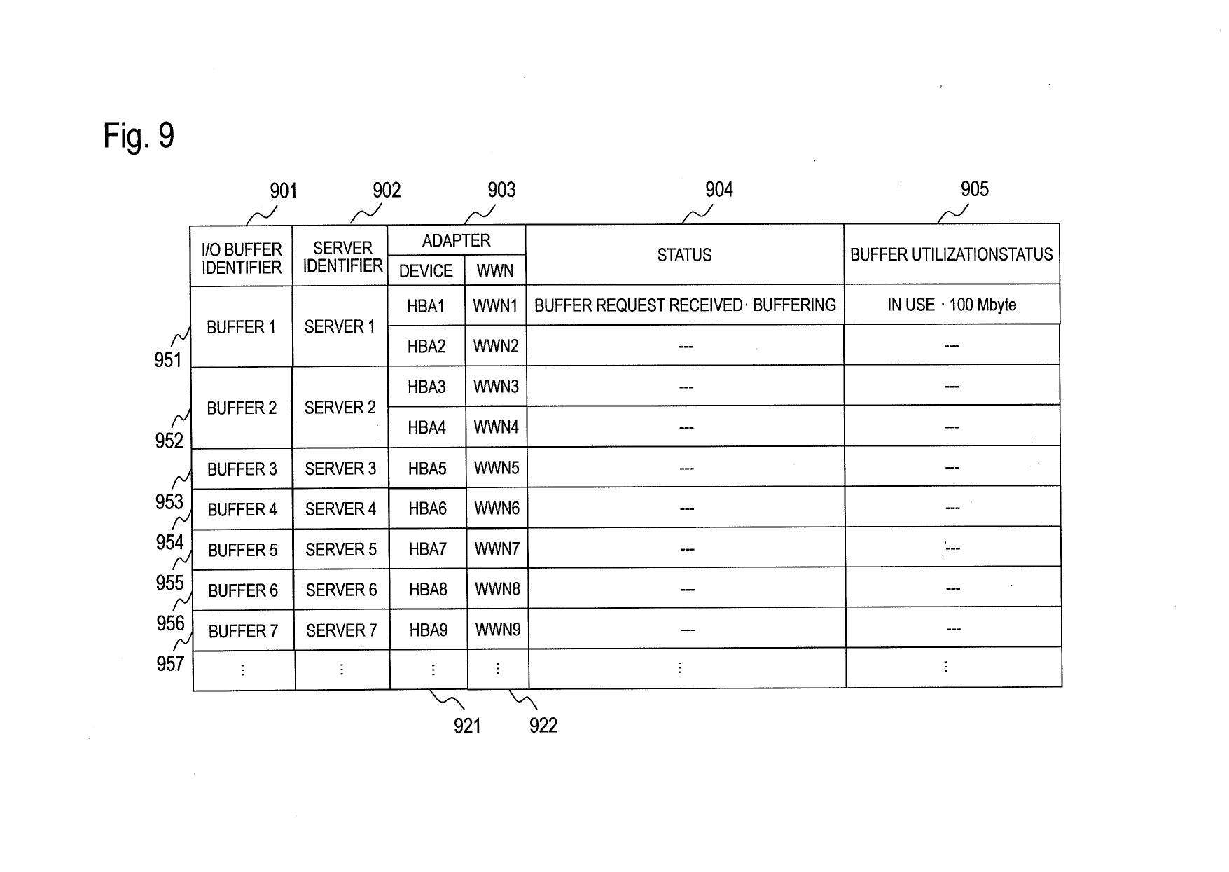

The management table group 442 includes an I/O buffering management table 411 (see FIG. 9).

The PCIex-SW 107 also includes ports that are connected to the servers 102 and 106 (upstream ports) and ports that are connected to the adapters 451-1 to 451-5 (downstream ports) as described later. The control module 441 can change which ones of the adapters 451-1 to 451-5 are allocated to the servers 102 and 106 by changing the connection relation of the upstream ports and the downstream ports. While there are five adapters, 451-1 to 451-5, in the example of FIG. 4, the computer system may have a larger number of adapters 451 including NICs and HBAs as illustrated in FIG. 1. This embodiment discusses an example in which HBAs constitute the adapters 451-1 to 451-3.

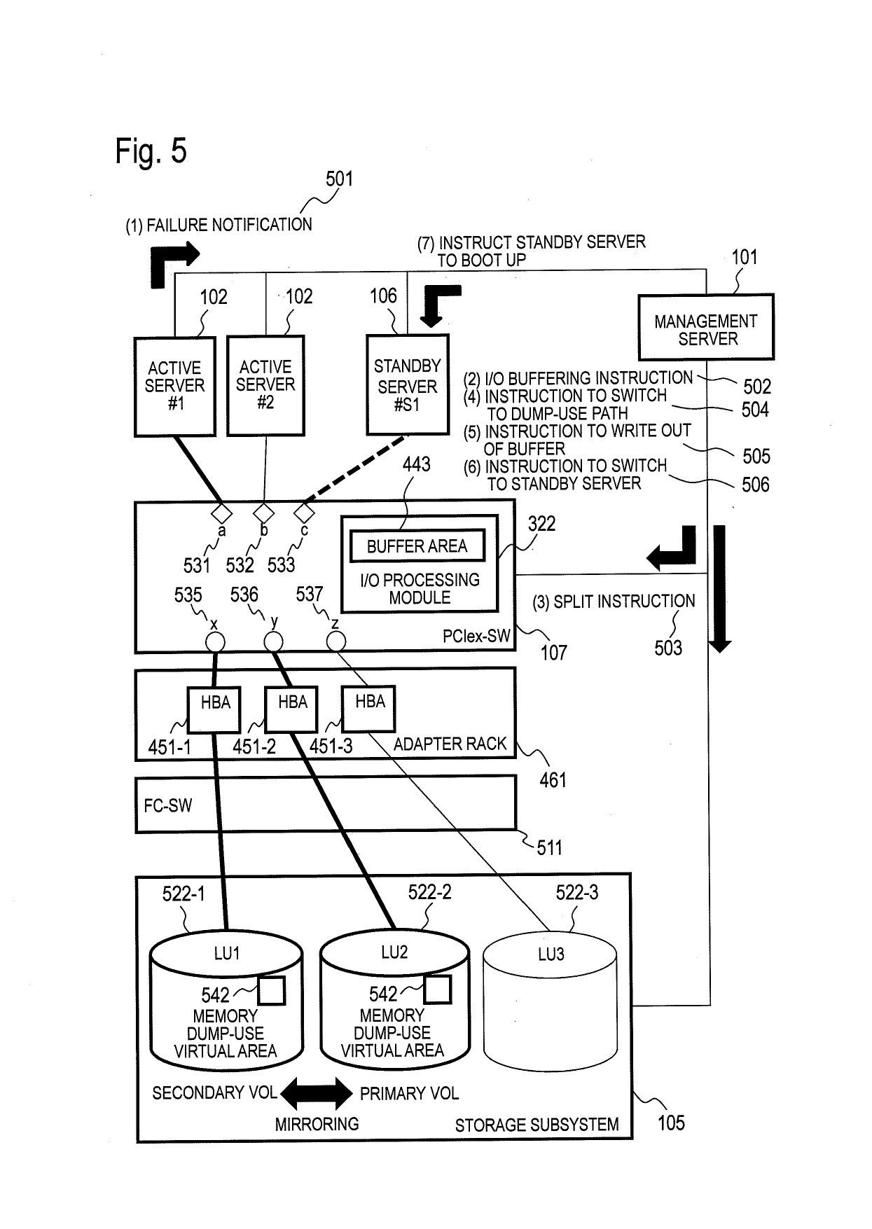

FIG. 5 is a block diagram outlining failover which is led by the PCIex-SW 107. In the example of FIG. 5, a failure has occurred in one of the active servers 102 (hereinafter active server #1) and system switching to one of the standby servers 106 (hereinafter standby server #S1) is executed while conducting memory dump of the active server #1.

A premise is that the active server #1 and the standby server #S1 are connected respectively to a port a 531 and port c 533 of the PCIex-SW 107. As a storage area of the storage subsystem 105 that is allocated to the active server #1 via the PCIex-SW 107, a logical volume LU2 (522-2) is connected to a port y 536 and functions as a primary volume. The logical volume LU2 stores a boot image of the OS, a service application program, and the like. A logical volume LU1 (522-1) is set as a secondary volume of the primary volume LU1, and constitutes a mirror volume to which data stored in the primary volume LU2 is copied. The adapter 451-2 constituted of an HBA is connected to the port y 536, and is connected to the primary volume LU2 via the FC-SW 511. The adapter 451-1 constituted of an HBA is connected to a port x 535.

When the active server #1 writes data in the primary volume LU2 which is a part of mirroring volumes, the data stored in the primary volume LU2 is copied to the secondary volume LU1 by a mirroring function of the storage subsystem 105.

The PCIex-SW 107 connects the port a 531 and the port y 536 to allow the active server #1 to access the primary volume LU2 via the adapter 451-2 constituted of an HBA. Data written in the primary volume LU2 is copied to the secondary volume LU1 by the storage subsystem 105. A memory dump-use virtual area 542 is set in the primary volume LU2 (and in the secondary volume LU1) as an area for dumping data stored in the memory 302 of the active server #1 when a failure occurs.

With (1) the reception of a failure notification 501 sent from the standby server #S1 (or another active server 102) as a trigger, the management server 101 makes a switch from a configuration in which the port a 531 and the port y 536 are connected by (2) issuing an I/O buffering instruction to the I/O processing module 322 and connecting the port a 531 to the I/O processing module 322. The management server 101 then switches to a configuration in which I/O (memory dump) of the failing active server #1 can be accumulated in the buffer area 443 within the I/O processing module (502).

The failing active server #1 has started outputting (transmitting) memory dump as soon as the failure occurs, and a part of the memory dump has already been output to the memory dump-use virtual area 542 of the primary volume LU2 (522-2). In this embodiment, the primary volume LU2 (522-2) and the secondary volume LU1 constitute a mirror configuration to copy the already output memory dump to the secondary volume LU1 without missing a piece. The I/O processing module 322 accumulates memory dump from the active server 102 in the buffer area 402. The I/O processing module 322 makes it possible to collect all pieces of memory dump data by subsequently writing the memory dump that has been buffered in the buffer area 443.

(3) The storage control module 212 of the management server 101 issues an instruction to split the mirroring of the primary volume LU2 and the secondary volume LU1 (503). The storage control module 212 may issue an instruction to synchronize the mirroring mandatorily before the split. In the case of inserting mirroring synchronizing processing mandatorily, the split is executed after the synchronizing processing is finished. The storage control module 212 next issues an instruction to turn the secondary volume LU1 which has undergone the split into a primary volume. This creates two logical volumes, LU1 and LU2, that hold memory dump written in the memory dump-use virtual area 542 of the primary volume LU2 as soon as the failure occurs. Each of the two logical volumes is coupled to the server 102 or 106, which makes it possible to resume the service once reboot is executed, and to collect memory dump without missing a piece even when the writing of memory dump is continued.

At this point, the primary volume LU1 which is coupled to the standby server 106 to resume the service is paired with another logical volume LUn (a third storage module) as a secondary volume of a mirror configuration, to thereby switch to another system quickly in the event of another failure while obtaining the effects of this invention.

(4) The path switching module 213 (see FIG. 12) connects the above-mentioned two primary volumes LU1 and LU2 to the I/O processing module 322 (504). Specifically, the buffer area 443 of the I/O processing module 322 is connected to the port x 535 so as to be connected to the primary volume LU1 via the HBA 451-1. In this step, the logical volume LU1 which is originally the second volume may be selected as a place to which the memory dump is written out, or may be coupled to the standby server 106. In the case where the primary volume LU1 is selected as a place where memory dump is written out, the remaining logical volume LU2 (the logical volume LU 522-2 which has been the primary volume at first and originally provided the service) is coupled to the standby server 106 (#S1). The merit of employing this configuration is that there is no change to the HBA 451-2 before and after the switching. This way, it seems to a group of software applications including an OS and middleware that runs the standby server #S1 and provides the service as though a simple switch from the active server #1 to the standby server #S1 has taken place (as though only the server part (mainly the CPU and the memory) has been switched), and the risk of adverse effects to the running of the system after the switch is therefore low. The adverse effects include not only a failure to boot but also the need to reinstall a device driver as a result of the OS recognizing a device change after boot, and the discarding of OS settings information (which means that the information needs to be set again) due to the reinstallation. These adverse effects can be avoided with the above-mentioned configuration. However, any of the logical volumes LU1 and LU2 can be used in the case where it is known that switching the HBA 451-2 to another HBA does not particularly pose a problem in continuing the service, or in the case where countermeasures are taken. As an example, this embodiment gives a detailed description of a case where the I/O processing module 322 is connected to the port x 535 of the PCIex-SW 107 to write data stored in the buffer area 443.

In this case, the failing active server #1 is connected to the port a 531 of the PCIex-SW 107, and is therefore coupled via the I/O processing module 322 to the secondary volume LU2, which has originally been paired with the current primary volume.

(5) The I/O buffer write-out instructing module 214 (see FIG. 13) issues an instruction to the I/O processing module 322 to write the accumulated memory dump out of the buffer area 443 (505). Buffered data is thus written out of the buffer area 443 to be added to the memory dump-use virtual area 542 of the logical volume LU1.

In this manner, memory dump data written out as soon as a failure occurs can be stored in the logical volume LU1 without missing a piece.

(6) The N+M switching instructing module 215 (FIG. 14) instructs the PCIex-SW 107 to couple the logical volume LU2 and the standby server #S1. Specifically, the port c 533 and port y 536 of the PCIex-SW 107 are connected (506).

In the manner described above, the switch to and reboot on the standby server #S1 can be executed while collecting memory dump, even when the OS is of the type to set up the memory dump-use virtual area 542 in the same logical volume as the boot-use logical volume LU2, or the type to allow the presence of the memory dump-use virtual area 542 only in one logical volume.

The above-mentioned processing of (4), (5), and (6) may be executed in parallel and, that way, the standby server #S1 can start booting earlier, thereby accomplishing even faster switching.

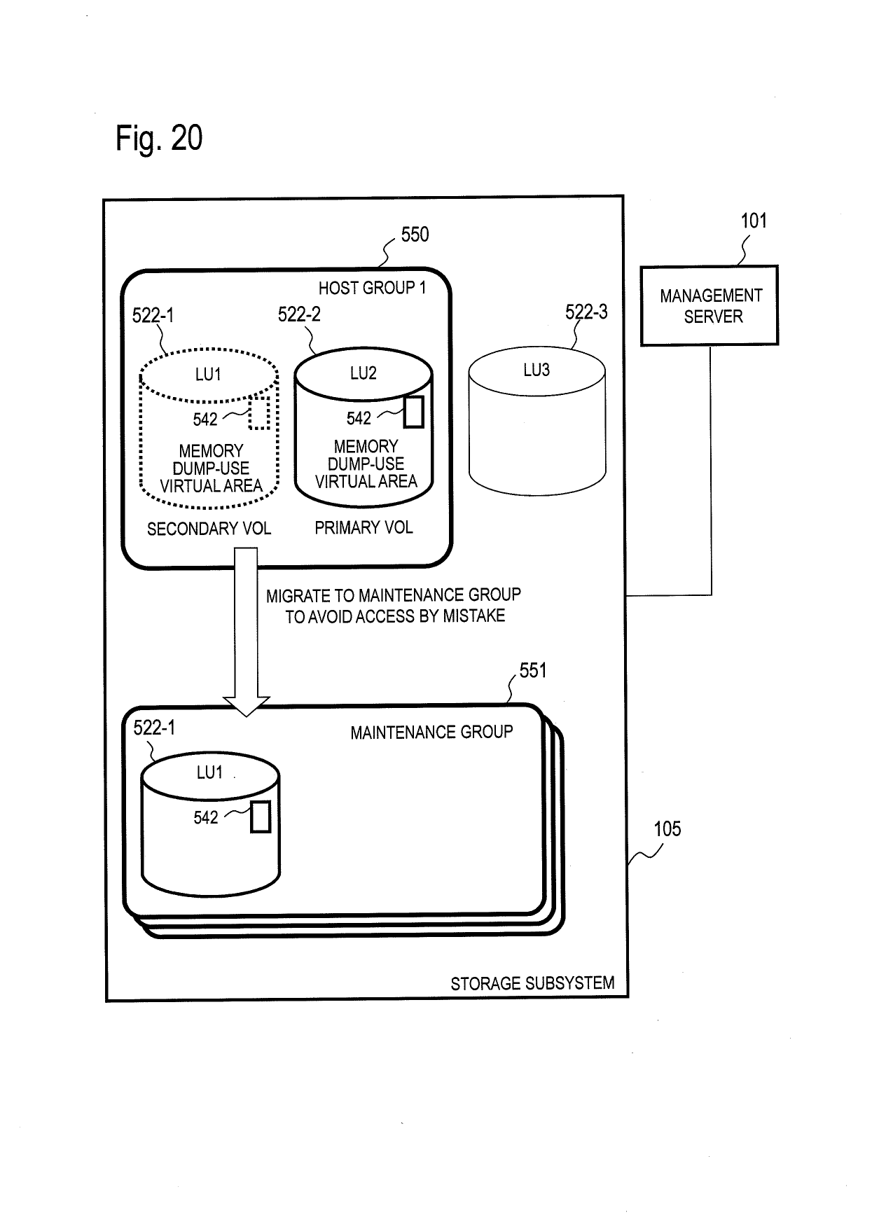

Once the writing of memory dump is finished, the logical volume LU1 may be evacuated to a maintenance-use area, or protected by access control, in order to prevent the loss of the logical volume LU1 where memory dump is collected due to wrong operation, and thereby enhance the effects of this embodiment further. This example is described later with reference to FIG. 20.

FIG. 6 is an explanatory diagram illustrating the server management table 221. The server management table 221 is managed by the control module 110 of the management server 101.

A column 601 stores the identifiers of the servers 102 and 106 which are used to identify each server 102 and each server 106 uniquely. Inputting data to be stored in the column 601 can be omitted by specifying one of columns that are used in this table, or a combination of a plurality of columns among the table's columns. The identifiers may be assigned automatically in ascending order or the like by the management server 101 or the like.

A column 602 stores a Universal Unique Identifier (UUID). UUID is an identifier having a format that is defined to avoid duplication. Holding a UUID in association with each server 102 and each 106 ensures that each server 102 and each server 106 have a unique identifier. However, the use of UUID is desirable, not indispensable, because identifiers set in the column 601 only need to be ones with which the system administrator can identify servers, and to include no duplications among the managed servers 102 and 106. For instance, a MAC address or World Wide Name (WWN) may be used for server identifiers of the column 601.

A column 603 stores “active server” or “standby server” as the server type. The column 603 may also store information indicating from which server a switch has been made in the case where system switching has been executed.

A column 604 stores, as the status of the servers 102 and 106, “normal” in the case where there is no problem and “failure” in the case where a failure has occurred. The column 604 may store information such as “writing out memory dump” in the case of a failure.

A column 605 (a column 621 and a column 622) stores information about the adapters 451. The column 621 stores, as the device type of the adapters 451, “HBA” (host bus adapter), “NIC”, or “CNA” (converged network adapter). The column 622 stores a WWN that is the identifier of an HBA or a MAC address that is the identifier of an NIC.

A column 606 stores information about the NW-SW 103 and the NW-SW 104 to which the active servers 102 and the standby servers 106 are coupled via the adapters 451, and information about the FC-SW 511. The stored information includes the type, a connected port, and security settings information.

A column 607 stores the server model which is information about the infrastructure and from which performance and limits to the configurable system can be known. The server model is also information that can be used to determine whether one server has the same configuration as that of another server.

A column 608 stores the server configuration which includes the processor architecture, physical location information of chassis, slots, and the like, and characteristic functions (whether inter-blade symmetric multi-processing (SMP), the HA configuration, or the like is included or not).

A column 609 stores server performance information.

FIG. 7 is an explanatory diagram illustrating the LU mapping management table 222. The LU mapping management table 222 is managed by the control module 110 of the management server 101, and stores connection relations among the logical volumes 522, the adapters 451, and the servers 102 and 106.

A column 701 stores the identifiers of LUs within the storage subsystem 105 which are used to uniquely identify each logical volume.

A column 702 (a column 721 and a column 722) stores information about the adapters 451. The column 721 stores, as the device type, “HBA” (host bus adapter), “NIC”, or “CNA” (converged network adapter). The column 722 stores a WWN that is the identifier of an HBA or a MAC address that is the identifier of an NIC.

A column 703 stores PCIex-SW information. The stored information indicates which ports of the PCIex-SW 107 have a connection relation with each other and the connection relation with the I/O processing module 322.

FIG. 8 is an explanatory diagram illustrating the LU management table 223. The LU management table 223 is managed by the control module 110 of the management server 101, and is used to manage the type of a logical volume, whether or not mirroring is conducted, volumes paired for mirroring, and the status.

A column 801 stores the identifiers of logical volumes which are used to uniquely identify each logical volume.

A column 802 stores, as the logical volume type, for example, information indicating the master-slave relation in mirroring such as whether the volume is a primary volume or a secondary volume.

A column 803 stores the identifier of a secondary volume paired for mirroring with the volume in question.

A column 804 stores, as the logical volume status, “mirroring”, “split”, “turning from secondary volume to primary volume”, “mirroring scheduled”, or the like.

FIG. 9 is an explanatory diagram illustrating the I/O buffering management table 411 within the I/O processing module 322 of the PCIex-SW 107. The I/O buffering management table 411 is managed by the control module 441, and is used to manage which server 102 and adapter 451 are connected to the buffer area 443, and the status of the buffer area 443.

A column 901 stores the identifiers of I/O buffers which are used to uniquely identify each buffer area 443. Identifiers set in advance by the control module 441 can be used as the buffer identifiers.

A column 902 stores the identifiers of the servers 102 and 106 which are used to uniquely identify each server 102 and each server 106. Values obtained from the server management table 221 of the management server 101 can be used as the server identifiers.

A column 903 (a column 921 and a column 922) stores information about the adapters 451. The column 921 stores, as the device type, “HBA” (host bus adapter), “NIC”, or “CNA” (converged network adapter). The column 922 stores a WWN that is the identifier of an HBA or an MAC address that is the identifier of an NIC. Values obtained from the server management table 221 of the management server 101 are stored as the information about the adapters 451. Alternatively, values used for access to the adapters 451 from the control module 441 may be stored.

A column 904 stores, as the status of the buffer area 443, “buffer request received”, “buffering data”, “writing out buffered data”, or the like.

A column 905 stores, as the utilization status of the buffer area 443, whether the buffer area 443 is in use or not in use and, in the case where the buffer area 443 is in use, the used capacity, error information, and the like. The column 905 also stores information about a capacity to be reserved and priority order so that data of which buffer area needs to be rescued can be determined when a request to buffer data that exceeds the capacity of the buffer area 443 is issued.

The column 902 and the column 903 may store, as an adapter, a device, or a server, information that can be substituted with a port number or slot number of the PCIex-SW 107.

The I/O buffering management table 411 may be provided further with a column for storing a method of dealing with a failure to buffer in the buffering area 443. Examples of the method include issuing a re-transmission request to the active server 102 and sending a failure notification to the management server 101. The management server 101 may notify the failing active server 102 of the adapter 451 that is connected to another logical volume so that stored data is written out of the memory 302 to the other logical volume. Overflowing data can thus be rescued.

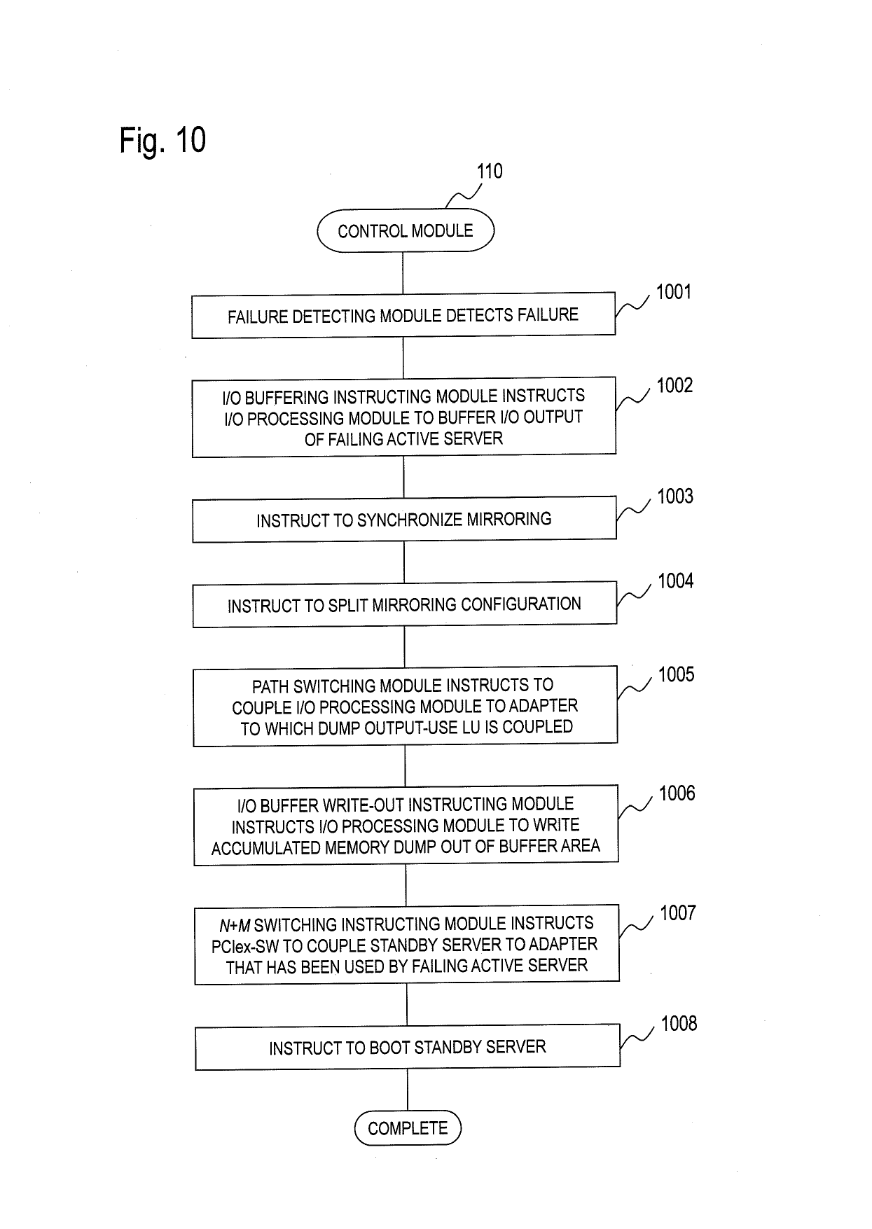

FIG. 10 is a flow chart illustrating an example of processing that is executed in the control module 110 of the management server 101. This processing is activated when the management server 101 receives the failure notification 501 from one of the servers 102 or one of the servers 106. The failure notification 501 is transmitted to the management server 101 when a failure is detected by the BMC 305, the OS 311, or other components of the server 102 or 106. The following description uses values illustrated in FIG. 5 as an active server identifier and logical volume identifiers.

In Step 1001, the failure detecting module 210 detects a failure from the failure notification 501. When a failure is detected, the processing proceeds to Step 1002.

In Step 1002, the I/O buffering instructing module 211 instructs the I/O processing module 322 to buffer I/O output (memory dump) of the active server #1 where the failure has occurred. The processing proceeds to Step 1003.

In Step 1003, the storage control module 212 instructs the storage subsystem 105 to perform mirroring synchronizing processing on the primary volume LU2, which is used by the active server #1. The processing proceeds to Step 1004.

In Step 1004, the storage control module 212 instructs the storage subsystem 105 to split the mirroring configuration of the primary volume LU2, and the processing proceeds to Step 1005. After the split, the secondary volume LU1 which has been paired with LU2 is turned into a primary volume, if necessary. Alternatively, another secondary volume may be prepared to be paired with one of the original logical volumes (the logical volume that is coupled to the standby server 106 to resume the service), thereby reconstructing a mirroring configuration.

In Step 1005, the path switching module 213 instructs to connect the I/O processing module 322 to one of the adapters 451 (the device that is connected to the logical volume LU1 to which memory dump is output). The processing proceeds to Step 1006.

In Step 1006, the I/O buffer write-out instructing module 214 instructs the I/O processing module 322 to write accumulated memory dump data out of the buffer area 443 to the LU1 set in Step 1005. The processing proceeds to Step 1007.

In Step 1007, the N+M switching instructing module 215 instructs the PCIex-SW 107 to connect the standby server #S1 to the adapter 451 (LU2) that has been used by the failing active server #1. The processing proceeds to Step 1008.

In Step 1008, an instruction is given to boot the standby server #S1, and the processing is completed.

Through the processing described above, the management server 101 receives the failure notification 501 from the active server #1 as illustrated in FIG. 5 and transmits an instruction to the PCIex-SW 107 to store I/O output from the active server #1 in the buffer area 443. The management server 101 next transmits an instruction to the storage subsystem 105 to synchronize mirroring for the primary volume LU2, which is used by the active server #1, thereby synchronizing the primary volume LU2 and the secondary volume LU1. Thereafter, the management server 101 transmits to the mirror volumes of the storage subsystem 105 a splitting instruction, namely, an instruction to dissolve the mirroring pair. The management server 101 next instructs the control module 441 of the PCIex-SW 107 to write stored data out of the buffer area 443 to the logical volume LU1, which is one of the volumes that have formed the now dissolved mirroring pair. The management server 101 further instructs the PCIex-SW 107 to set the logical volume LU2, which is the other of the volumes that have formed the now dissolved mirroring pair, as a primary volume and to couple the logical volume LU2 to the standby server #S1. The management server 101 then instructs the standby server #S1 to boot, and completes failover.

System switching to the standby server #S1 can thus be carried out speedily while collecting memory dump of the failing active server #1 without fail regardless of the type of the OS. In particular, by conducting memory dump of the failing active server #1 and system switching to the standby server #S1 in parallel after the mirror volumes LU1 and LU2 are split, the system switching can be started without waiting for the completion of memory dump, and failover can be accordingly sped up.

FIG. 11 is a flow chart illustrating an example of processing that is executed in the I/O buffering instructing module 211 of the management server 101. This processing is executed in Step 1002 of FIG. 10.

In Step 1101, the I/O buffering instructing module 211 refers to the server management table 221, and the processing proceeds to Step 1102.

In Step 1102, the I/O buffering instructing module 211 identifies, from the failure notification 501 and the server management table 221, the adapter 451 and a connection port of the PCIex-SW 107 that are connected to the failing active server #1. The processing proceeds to Step 1103.

In Step 1103, the I/O buffering instructing module 211 instructs the I/O processing module 322 to connect the connection port of the PCIex-SW 107 that has been identified in Step 1004 to the buffer area 443 of the I/O processing module 322. The processing proceeds to Step 1104.

In Step 1104, the I/O buffering instructing module 211 instructs the I/O processing module 322 to buffer I/O output from the active server #1. The processing proceeds to Step 1105.

In Step 1105, the I/O buffering instructing module 211 updates the I/O buffering management table 411 and completes the processing.

Through the processing described above, I/O output from the failing active server #1 is stored in the buffer area 443 of the PCIex-SW 107.

FIG. 12 is a flow chart illustrating an example of processing that is executed in the path switching module 213 of the management server 101. This processing is executed in Step 1005 of FIG. 10.

In Step 1201, the path switching module 213 refers to the LU management table 223 to identify LU1 paired with an LU that is allocated to the failing active server #1. The processing proceeds to Step 1202.

In Step 1202, the path switching module 213 refers to the LU mapping management table 222 to identify the relation between the LU allocated to the failing active server #1 and a port. The processing proceeds to Step 1203.

In Step 1203, the path switching module 213 gives an instruction to couple the buffer area 443 of the I/O processing module 322 and the memory dump output-use logical volume LU1 (which has originally been a secondary volume and then split), and finishes the processing.

Through the processing described above, the secondary volume LU1 is coupled to the buffer area 443 so that data stored in the buffer area 443 can be written in the logical volume LU1.

FIG. 13 is a flow chart illustrating an example of processing that is executed in the I/O buffer write-out instructing module 214 of the management server 101. This processing is executed in Step 1006 of FIG. 10.

In Step 1301, the I/O buffer write-out instructing module 214 instructs the I/O processing module 322 to write accumulated I/O data out of the buffer area 443, and the processing proceeds to Step 1302.

In Step 1302, the I/O buffer write-out instructing module 214 updates the I/O buffering management table 411 with respect to the buffer area 443 for which write-out has been instructed, and finishes the processing.

Through the processing described above, memory dump stored in the buffer area 433 of the PCIex-SW 107 is written in LU1, which has formed the pair now dissolved by the split.

FIG. 14 is a flow chart illustrating an example of processing that is executed in the N+M switching instructing module 215 of the management server 101. This processing is executed in Step 1007 of FIG. 10.

In Step 1401, the N+M switching instructing module 215 refers to the server management table 221 to identify the active server #1 where a failure has occurred and the standby server #S1 which is to take over the service of the active server #1. The processing proceeds to Step 1402.

In Step 1402, the N+M switching instructing module 215 instructs the PCIex-SW 107 to connect the auxiliary server #S1 identified in Step 1401 to the adapter 451 that has been used by the failing active server #1. The processing proceeds to Step 1403.

In Step 1403, the N+M switching instructing module 215 updates the LU management table 223 with respect to the logical volume LU2 coupled to the standby server #S1. The processing proceeds to Step 1404.

In Step 1404, the N+M switching instructing module 215 updates the LU mapping management table 222 with respect to the logical volume LU2 coupled to the standby server #S1. The processing proceeds to Step 1405.

In Step 1405, the N+M switching instructing module 215 updates the server management table 221 with respect to the failing active server #1 and the standby server #S1, which takes over the service of the failing server, and finishes the processing.

Through the processing described above, the standby server #S1 takes over the logical volume LU2 of the failing active server #1.

FIG. 15 is a flow chart illustrating an example of processing that is executed in the I/O buffering control module 401 of the I/O processing module 322. This processing is executed in Step 1104 of FIG. 11.

In Step 1501, the I/O buffering control module 401 refers to the I/O buffering management table 411 to identify the buffer area 443 to which memory dump is written. The processing proceeds to Step 1502.

In Step 1502, the failing active server #1, the I/O processing module 322, and the buffer area 443 are connected, and the processing proceeds to Step 1503.

In Step 1503, the I/O buffering control module 401 buffers I/O data from the active server #1 in the identified buffer area 443, and finishes the processing.

FIG. 16 is an explanatory diagram illustrating an example of the service and SLA management table 224 which is managed by the management server 101. The service and SLA management table 224 is used to manage, for each of services provided by the active servers 102, information such as the nature of the service, what software is used, what settings are set, which service level needs to be satisfied to what degree, and the place in priority order of the service.

A column 1601 stores service identifiers which are used to uniquely identify each service.

A column 1602 stores UUIDs which are candidates for service identifiers stored in the column 1601 and are very effective for server management that spans a wide range. However, using UUID is just preferred and other identifiers than UUID may be used, because identifiers set in the column 1601 only need to be ones with which the system administrator can identify servers, and to include no duplications among the managed servers. For instance, service settings information (stored in a column 1604) may be used for server identifiers of the column 1601.

A column 1603 stores, as the service type, information about software with which a service is identified, such as which application or middleware is used. The column 1604 stores a logical IP address or an ID that is used by a service, a password, a disk image, a port number that is used by the service, and the like. The disk image refers to that of a system disk in which the service before and after being set is distributed to the OS of the relevant active server 102. The information about a disk image that the column 1604 stores may include a data disk.

A column 1605 stores priority order and SLA settings which are priority order among services and requirements for the respective services. Which service needs to be rescued preferentially, whether memory dump collection is necessary or not, and whether quick N+M switching is necessary or not can thus be set. In this invention, how the buffer area 443 is used is an important point and can determine a system running mode where the effects of this invention are obtained most.

In the case where “SLA: memory dump unnecessary” is stored in the column 1605 of the service and SLA management table 224, the management server 101 executes failover without performing the processing of FIG. 5.

FIG. 20 is a diagram illustrating an example of processing of evacuating LU1 to a preset maintenance-use area after memory dump write to LU1 is finished. Once memory dump write to LU1 is finished, the management server 101 separates LU1 from a host group 1 (550) which is used by the standby server #S1, adds LU1 to a maintenance group 551 set in advance, and controls access to LU1.

As has been described, according to the first embodiment of this invention, I/O output (memory dump, in particular) from the active server #1 where a failure has occurred is collected to the logical volume LU1, without fail, regardless of the OS type, to be migrated to the maintenance group 551. Wrong operation such as deleting the contents of memory dump by mistake can thus be prevented.

### Second Embodiment

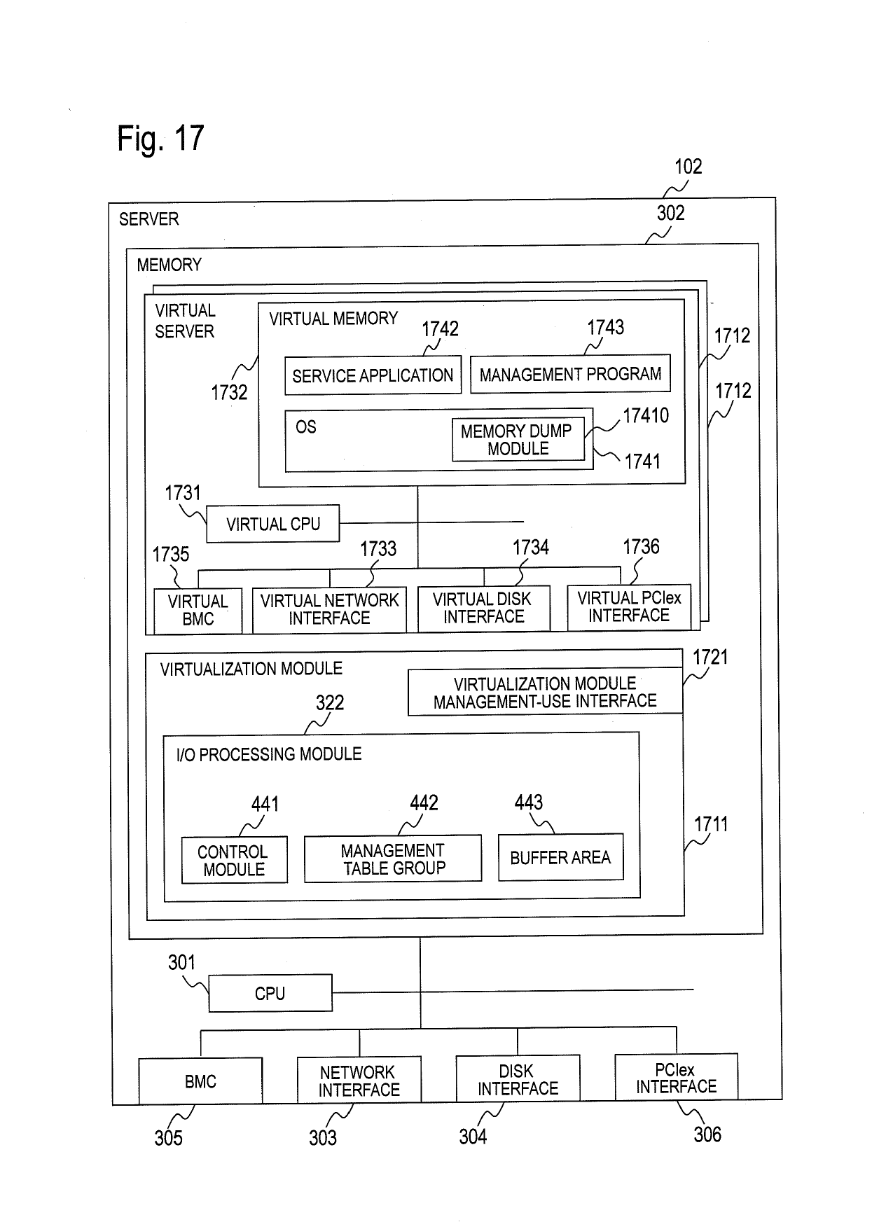

FIG. 17 is a block diagram illustrating one of the servers 102 (or 106) in a second embodiment. The second embodiment is a modification of the first embodiment in which the I/O processing module 322 is incorporated in a virtualization module 1711. Components that are the same as those in the first embodiment described above are denoted by the same reference symbols, and descriptions thereof are omitted here. FIG. 17 illustrates the configurations of the server 102, the virtualization module 1711, and virtual servers 1712. The virtualization module 1711 virtualizes physical computer resources of the server 102 to provide the plurality of virtual servers 1712. A virtual machine monitor (VMM) or a hypervisor can constitute the virtualization module 1711.

The virtualization module 1711 which provides a server virtualization technology for virtualizing physical computer resources is deployed in the memory 302, and provides the virtual servers 1712. The virtualization module 1711 includes a virtualization module management-use interface 1721 as a control-use interface.

The virtualization module 1711 virtualizes physical computer resources of the server 102 (may also be a blade server) to configure the virtual servers 1712. The virtual servers 1712 each include a virtual CPU 1731, a virtual memory 1732, a virtual network interface 1733, a virtual disk interface 1734, and a virtual PCIex interface 1736. An OS 1741 is deployed in the virtual memory 1732 to manage a virtual device group within the virtual server 1712. A service application 1742 is executed on the OS 1741. A management program 1743 run on the OS 1741 provides failure detection, OS power supply control, inventory management, and the like. The virtualization module 1711 manages the association between a physical computer resource and a virtual computer resource, and is capable of associating or disassociating a physical computer resource and a virtual computer resource with or from each other. The virtualization module 1711 also holds configuration information, such as which virtual server 1712 is allocated and using how many computer resources of the server 102, and operating history. The OS 1741 includes, as in the first embodiment, a memory dump module 17410 which outputs data stored in the virtual memory 1732 under a given condition.

The virtualization module management-use interface 1721 is an interface for communicating to/from the management server 101, and is used to notify the management server 101 of information from the virtualization module 1711 and to send an instruction to the virtualization module 1711 from the management server 101. A user may directly use the virtualization module management-use interface 1721.

The virtualization module 1711 contains the I/O processing module 322, which is involved in, for example, a connection between the virtual PCIex interface 1735 and the physical PCIex interface 306. When a failure occurs in one of the virtual servers 1712, the I/O processing module 322 executes failover in which the service is resumed on another virtual server (on the same physical server or on another physical server) while obtaining dump from the virtual memory 1732.

In the second embodiment, although the PCIex-SW 107 of the first embodiment can be used to couple the servers 102 and the storage subsystem 105, the virtualization module 1711 is capable of switching connection relations between the plurality of virtual servers 1712 and LUs without switching paths inside the PCIex-SW 107.

The server 102 in the second embodiment therefore includes as many disk interfaces 304 as the number of paths to LUs of the storage subsystem 105 that are used by the virtual servers 1712, here, 304-1 and 304-2. The following description discusses a case where the disk interfaces 304-1 and 304-2 of the server 102 are coupled to the LU2 (and LU1) of the storage subsystem 105 via the FC-SW 511 (see FIG. 1).

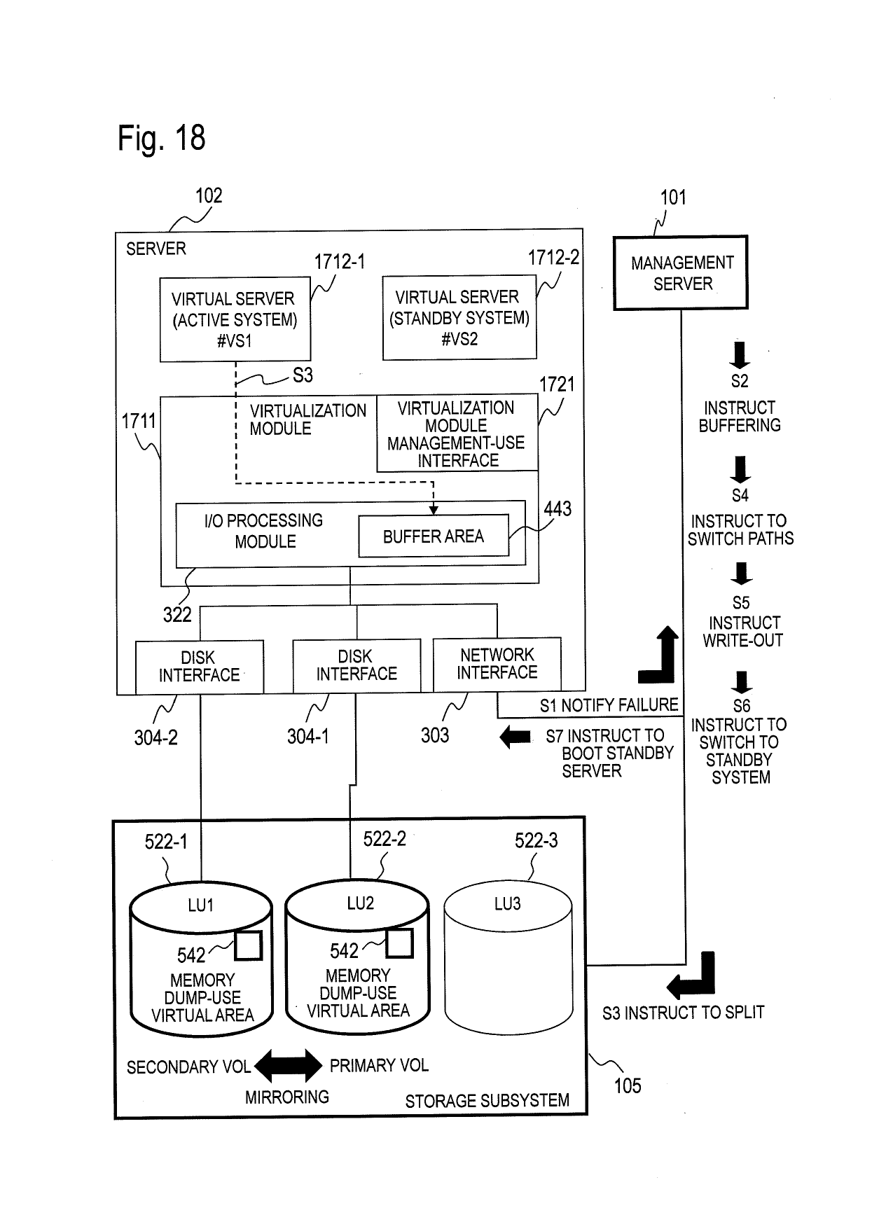

FIG. 18 is diagram outlining processing of the second embodiment. FIG. 18 illustrates an example in which a virtual server #VS1 (1721-1) operates as an active server and, when a failure occurs in the virtual server #VS1, a virtual server #VS2 (1712-2) which functions as a standby system takes over processing while memory dump of the virtual server #VS1 is collected.

The active virtual server #VS1 accesses, as in FIG. 5 of the first embodiment, mirror volumes that have LU1 as the primary volume and LU2 as the secondary volume.

The virtualization module 1711 monitors the virtual memory of the virtual server #VS1, monitors writing from the virtual server #VS1 to the memory dump-use virtual area 542 of the storage subsystem 105, monitors reading of a system area (a memory dump-use program) of the OS 1741 on the virtual server #VS1 or the like, monitors for a system call for calling the memory dump-use program of the OS 1741, and monitors for a failure in the virtual server #VS1. The virtualization module 1711 also manages computer resource allocation to the standby virtual server #VS2 and the like. The management server 101 gives instructions via the virtualization module management-use interface 1721 of the virtualization module 1711.

When a failure occurs in the virtual server #VS1, the virtualization module 1711 transmits a failure notification to the management server 101 (S1). The management server 101 transmits an instruction to the virtualization module 1711 to store I/O output of the virtual server #VS1 in the buffer area 443 (S2).

The virtualization module 1711 switches the connection destination of the virtual disk interface 1734 of the active virtual server #VS1 to the buffer area 443 of the I/O processing module 322 (S3). This causes the failing virtual server #VS1 to store, in the buffer area 443 of the I/O processing module 322, data that has been stored in the virtual memory 1732.

The management server 101 next transmits to the storage subsystem 105 an instruction to split LU1 and LU2 which are coupled to the virtual server #VS1 (S3).

The management server 101 next transmits to the virtualization module 1711 an instruction to switch paths so that data stored in the buffer area 443 is written in LU1, which has been the secondary volume (S4). The virtualization module 1711 switches the connection destination of the buffer area 443 to the disk interface 304-2, which is coupled to LU1. The virtualization module 1711 thus writes, in LU1, data that has been stored in the buffer area 443.

The management server 101 transmits to the virtualization module 1711 an instruction to allocate the standby virtual server #VS2 to switch LU2 to the virtual server #VS2 (S6). Based on the instruction from the management server 101, the virtualization module 1711 allocates computer resources to the virtual server #VS2 and sets, as the connection destination of the virtual disk interface 1734, the disk interface 304-1 set for LU1.

The management server 101 transmits to the virtualization module 1711 an instruction to boot the standby virtual server #VS2 (S7). The virtualization module 1711 boots the virtual server #VS2 to which computer resources and the disk interface 304-1 have been allocated, and the virtual server #VS2 executes the OS 1741 and the service application 1742 in LU2. The virtual server #VS2 thus takes over the processing of the active virtual server #VS1.

As has been described, in the second embodiment, obtaining I/O output (memory dump, in particular) and failover are conducted in parallel when a failure occurs in the active virtual server #VS1, thereby speeding up system switching regardless of the type of the OS.

### Third Embodiment

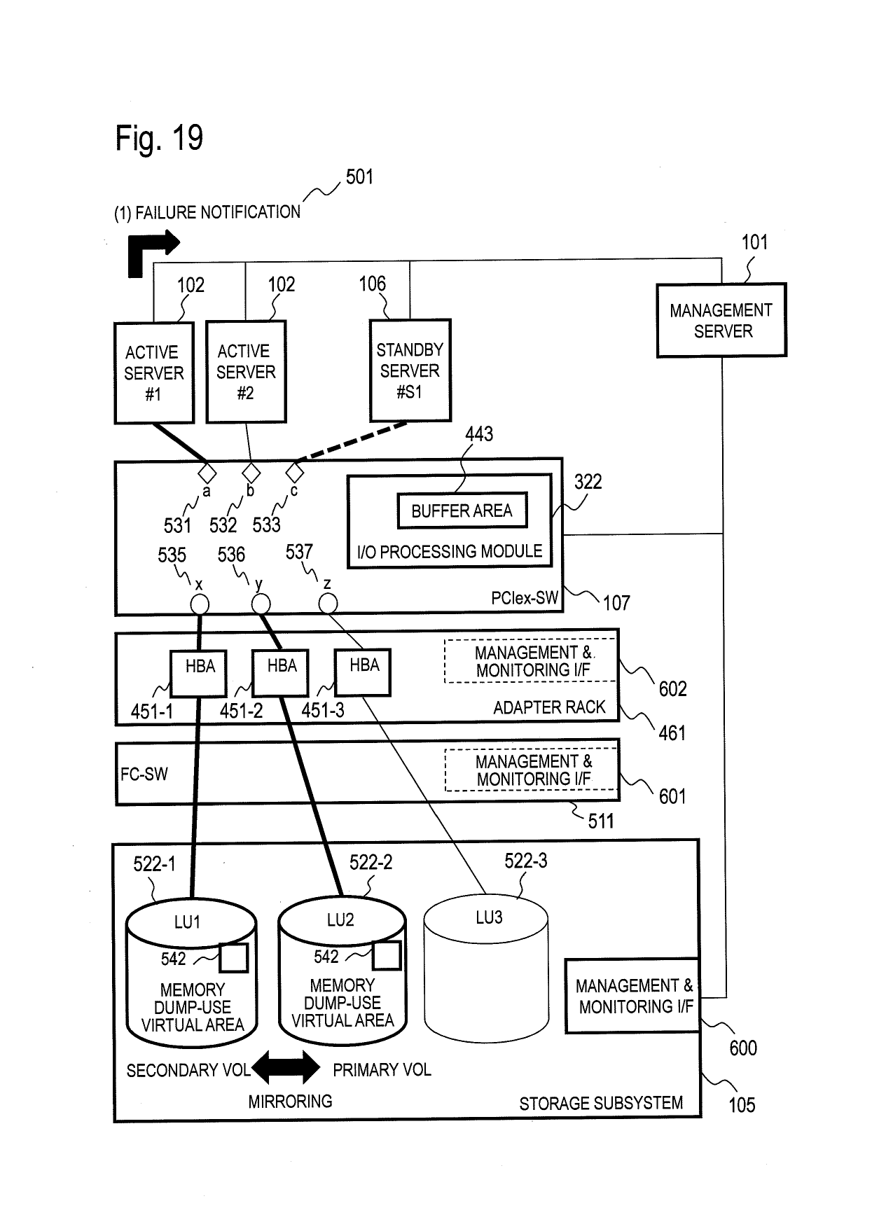

FIG. 19 is a diagram outlining failover that is led by the PCIex-SW 107 according to a third embodiment. In the third embodiment, the storage subsystem is provided with a management and monitoring interface 600, which monitors for write to the memory dump-use virtual area 542, so that failover and memory dump buffering are executed with the start of memory dump from the active server #1 (102) as a trigger. The rest of the configuration of the third embodiment is the same as in the first embodiment.

The management and monitoring interface 600 monitors LU1 as the primary volume accessed by the active server #1 for write to the memory dump-use virtual area 542. When write to the memory dump-use virtual area 542 is started, the management and monitoring interface 600 notifies the management server 101 of the memory dump from the active server #1.

When detecting the memory dump, the management server 101 executes failover from the active server #1 to the standby server #S1 and memory dump of the active server #1 in parallel the same way as in the first embodiment.

The management and monitoring interface 600 monitors for write to the memory dump-use virtual area 542, and also monitors for read of a system area (memory dump-use program) of the OS 311.

Write to the memory dump-use virtual area 542 is detected by the management and monitoring interface 600 by detecting whether there has been write for memory dump in a special area (block) within the storage subsystem 105. The location of the memory dump-use virtual area 542 may be identified by, for example, writing sample data in a special file for memory dump in advance, or by activating a program with the use of a pseudo failure and causing the program to write data for memory dump.

Other than the storage subsystem 105, the FC-SW 511 or the adapter rack 461 may be provided with a management and monitoring interface, as in the figure where management and monitoring interfaces 601 and 602 are provided. In this case, the management and monitoring interfaces 601 and 602 monitor I/O output by sniffing or the like to detect the start of memory dump from the address and the contents.

As has been described, according to the first to third embodiments, a computer system is provided with the I/O processing module 322, which includes the buffer area 443 for temporarily accumulating memory dump of the active server #1, and the PCIex-SW 107 or the virtualization module 1711, which serves as a path switching module for switching the path of the memory dump from the primary volume (LU1) of mirror volumes to the secondary volume (LU2). Memory dump can therefore be collected without fail regardless of the OS type, and wrong operation such as deleting the contents of memory dump by mistake is prevented.

In addition, system switching to the standby server #S1 and the obtainment of I/O output (memory dump) from the active server #1 are executed in parallel by booting the standby server #S1 from the primary volume (LU1) after the management server 101 splits the mirror volumes LU1 and LU2. This way, system switching can be started without waiting for the completion of the obtainment of I/O output (memory dump, in particular), thereby speeding up system switching (failover) that employs cold standby.

While the embodiments described above give an example in which LUs of the storage subsystem 105 constitute mirror volumes, mirror volumes may be constituted of physical disk devices.

The FC-SW 511, the NS-SW 103, and the NW-SW 104 separate a SAN and an IP network in the example given in the embodiments described above. Alternatively, an IP-SAN or the like may be used to provide a single network.

This invention has now been described in detail with reference to the accompanying drawings. However, this invention is not limited to those concrete configurations, and encompasses various modifications and equivalent configurations that are within the spirit of the scope of claims set forth below.

As described above, this invention is applicable to computer systems, I/O switches, or virtualization modules that switch systems using cold standby.

What is claimed is:

1. A computer system, comprising:
a first computer comprising a processor, a memory, and an I/O interface;
a second computer comprising a processor, a memory, and an I/O interface;
a storage apparatus accessible from the first computer and the second computer; and
a management computer coupled via a network to the first computer and the second computer to execute, at given timing, system switching in which the second computer takes over from the first computer,
wherein, when a given condition is satisfied, the first computer transmits an I/O output which is data stored in the memory to be written in the storage apparatus,
wherein the storage apparatus comprises a first storage module which is accessed by the first computer, and a second storage module to which data stored in the first storage module is copied by mirroring,
wherein the computer system further comprises:
an I/O processing module which comprises a buffer for temporarily storing the I/O output between the first computer and the storage apparatus and between the second computer and the storage apparatus, and a control module for outputting data stored in the buffer to the storage apparatus; and
a switch unit for switching paths by which the I/O processing module, the first computer, and the second computer access the storage apparatus, and
wherein the management computer comprises:
a buffering instructing module for transmitting, to the I/O processing module, when the given timing arrives, an instruction to store the I/O output of the first computer in the buffer;
a storage control module for transmitting to the storage apparatus an instruction to split the first storage module and the second storage module;
a path switching module for transmitting to the switch unit an instruction to connect the buffer and the second storage module, and to couple the second computer and the first storage module;
a write-out instructing module for transmitting to the I/O processing module an instruction to output the data stored in the buffer to the second storage module; and
a system switching module for booting the second computer from the first storage module.

2. The computer system according to claim 1,
wherein the management computer further comprises a failure detecting module for detecting that a failure has occurred in the first computer, and
wherein the system switching is executed with failure detection by the failure detecting module as the given timing.

3. The computer system according to claim 1,
wherein the management computer further comprises a monitoring module for detecting that the first computer has output the I/O output, and
wherein the management computer executes the system switching with detection of the I/O output from the first computer by the monitoring module as the given timing.

4. The computer system according to claim 1, wherein the storage control module moves the first storage module to a maintenance group, which is set in advance, after the I/O output to the first storage module is completed.

5. The computer system according to claim 1, wherein the storage control module sets a third storage module to which stored data is copied by mirroring from the second storage module accessed by the second computer.

6. The computer system according to claim 1, wherein the switch unit comprises an I/O switch for controlling a path running through an I/O device that couples the I/O interface of the first computer and the storage apparatus, and a path running through an I/O device that couples the I/O interface of the second computer and the storage apparatus.

7. The computer system according to claim 1, further comprising a virtualization module for virtualizing a physical computer,
wherein the virtualization module is configured to:
allocate a first virtual machine which comprises a virtual processor, a virtual memory, and a virtual I/O interface as the first computer;
allocate a second virtual machine which comprises a virtual processor, a virtual memory, and a virtual I/O interface as the second computer; and
control, as the switch unit, a path running through an I/O device that couples the virtual I/O interface of the first virtual machine and the storage apparatus, and a path running through an I/O device that couples the virtual I/O interface of the second virtual machine and the storage apparatus,
wherein the first computer comprises a memory dump module which outputs data stored in the virtual memory when a given condition is satisfied, and
wherein, when the given condition is satisfied, the memory dump module transmits to the virtual I/O interface an I/O output which is the data stored in the virtual memory to be written in the storage apparatus.

8. The computer system according to claim 1, wherein the path switching module transmits to the switch unit an instruction to connect the I/O interface of the first computer and the buffer, to connect the buffer and the second storage module, and to couple the I/O interface of the second computer and the first storage module.

9. A system switching control method for a computer system,
the computer system comprising:
a first computer comprising a processor, a memory, and an I/O interface;
a second computer comprising a processor, a memory, and an I/O interface;
a storage apparatus accessible from the first computer and the second computer; and
a management computer coupled via a network to the first computer and the second computer to execute, at given timing, system switching in which the second computer takes over from the first computer,
the first computer transmitting, when a given condition is satisfied, an I/O output which is data stored in the memory to be written in the storage apparatus,
the computer system further comprising:
an I/O processing module which comprises a buffer for temporarily storing the I/O output between the first computer and the storage apparatus and between the second computer and the storage apparatus, and a control module for outputting data stored in the buffer to the storage apparatus; and
a switch unit for switching paths by which the I/O processing module, the first computer, and the second computer access the storage apparatus, and
the system switching control method comprising:
a first step of setting, by the management computer, in the storage apparatus, a first storage module which is accessed by the first computer, and a second storage module to which data stored in the first storage module is copied by mirroring;
a second step of transmitting, by the management computer, to the I/O processing module, an instruction to store the I/O output of the first computer in the buffer when the given timing arrives;
a third step of transmitting, by the management computer, to the storage apparatus, an instruction to split the first storage module and the second storage module;
a fourth step of transmitting, by the management computer, to the switch unit, an instruction to connect the buffer and the second storage module, and to couple the second computer and the first storage module;
a fifth step of transmitting, by the management computer, to the I/O processing module, an instruction to output the data stored in the buffer to the second storage module; and
a sixth step of booting, by the management computer, the second computer from the first storage module.

10. The system switching control method according to claim 9, further comprising a step of detecting, by the management computer, that a failure has occurred in the first computer,
wherein the second step comprises transmitting the instruction to store the I/O output in the buffer with the detecting of the failure as the given timing.

11. The system switching control method according to claim 9,
wherein the computer system further comprises a monitoring module for detecting that the first computer has output the I/O output, and
wherein the second step comprises transmitting the instruction to store the I/O output in the buffer with detection of the I/O output from the first computer by the monitoring module as the given timing.

12. The system switching control method according to claim 9, further comprising a seventh step of transmitting, by the management computer, an instruction to move the first storage module to a maintenance group, which is set in advance, after the I/O output to the first storage module is completed.

13. The system switching control method according to claim 9, wherein the sixth step comprises a step of transmitting, by the management computer, to the storage apparatus, an instruction to set a third storage module to which stored data is copied by mirroring from the second storage module accessed by the second computer.

14. The system switching control method according to claim 9, further comprising a step of controlling, by the switch unit, a path running through an I/O device that couples the I/O interface of the first computer and the storage apparatus, and a path running through an I/O device that couples the I/O interface of the second computer and the storage apparatus.

15. The system switching control method according to claim 9,
wherein the first computer comprises a memory dump module for outputting data stored in the virtual memory when a given condition is satisfied,
wherein the computer system further comprises a virtualization module for virtualizing a physical computer, and
wherein the system switching control method further comprises the steps of:
allocating, by the virtualization module, a first virtual machine which comprises a virtual processor, a virtual memory, and a virtual I/O interface as the first computer;
allocating, by the virtualization module, a second virtual machine which comprises a virtual processor, a virtual memory, and a virtual I/O interface as the second computer;
controlling, by the virtualization module, as the switch unit, a path running through an I/O device that couples the virtual I/O interface of the first virtual machine and the storage apparatus, and a path running through an I/O device that couples the virtual I/O interface of the second virtual machine and the storage apparatus; and
when the given condition is satisfied, transmitting, by the memory dump module, to the virtual I/O interface, an I/O output which is data stored in the virtual memory to be written in the storage apparatus.

16. The system switching control method according to claim 9, wherein the fourth step comprises transmitting, by the management computer, to the switch unit an instruction to connect the I/O interface of the first computer and the buffer, to connect the buffer and the second storage module, and to couple the I/O interface of the second computer and the first storage module.
